(19) United States
(12) Patent Application Publication
(10) Pub. No.: US 2026/0262679 A1
(43) Pub. Date: Sep. 10, 2026

(54) SHAVED ICE MACHINE

(71) Applicant: Foshan Alpicool Holding Group Co., Ltd., Foshan (CN)

(72) Inventors: Pizhi ZHAO, Qingyuan (CN); YOUJING LIU, Zhanjiang (CN)

(21) Appl. No.: 19/661,465

(22) Filed: Apr. 28, 2026

(30) Foreign Application Priority Data
Nov. 28, 2025 (CN) 202522539123.9

(51) Int. Cl. A23G 9/04; A23G 9/12; A23G 9/28; A23G 9/30

(52) U.S. Cl. CPC A23G 9/045; A23G 9/12; A23G 9/281; A23G 9/30

(57) ABSTRACT

Provided is a shaved ice machine. It includes an installation shell, a tail of the installation shell is provided with a locking component, the installation shell is provided with an installation groove, a detachable loading bucket is provided inside the installation groove, the loading bucket is connected to the locking component, a front of the loading bucket is provided with a discharge component; the installation shell is provided with a stirring component, the stirring component is provided inside the loading bucket; a front bottom of the installation shell is provided with a front panel, and the front panel is provided with a control panel; a bottom of the front panel is provided with a machine base, the machine base is provided with a refrigeration component. The loading bucket is locked or unlocked by sliding guide blocks and guide groove with the locking component driven by an inverted U-shaped handle.

### CROSS-REFERENCE TO RELATED APPLICATIONS

This application claims priority to Chinese Patent Application No. 202522539123.9, filed on November 28, 2025, which is hereby incorporated by reference in its entirety.

### TECHNICAL FIELD

The present disclosure relates to the field of shaved ice machine technologies, and in particular, to a new type of shaved ice machine.

### BACKGROUND

In catering, beverage and other industries, as the core equipment for making smoothies and cold drinks, the ease of use, food safety and assembly efficiency of the shaved ice machine directly affect the user experience and production efficiency. However, there are still many urgent problems to be solved in the structural design of traditional shaved ice machines, mainly reflected in the following three aspects.

Firstly, there are defects in the installation of the loading bucket and the design of the condensate water treatment. The loading bucket of traditional shaved ice machines often adopts a fixed installation structure, which cannot be quickly disassembled, resulting in cumbersome and time-consuming cleaning, maintenance, or material replacement of the loading bucket in a later stage. At the same time, during the operation of the shaved ice machine, the low temperature generated by the refrigeration components will be transmitted to the loading bucket and adjacent installation shell surfaces, causing water vapor in the air to condense into condensate when cooled. However, existing equipment lacks targeted condensate water diversion and collection structures, and condensate water dripping randomly can easily pollute the surrounding environment of the equipment, and may even infiltrate the interior of the equipment, affect the service life of electrical components and increase the risk of equipment failure.

Secondly, the design of the discharge mechanism is difficult to balance practicality, safety, and economy. At present, the mainstream discharge mechanisms are mainly divided into two categories: one is a double link mechanism that moves up and down. Although it has advantages of simple structure and low manufacturing cost, it has fatal defects in practical applications, due to viscous components such as sugar and milk fat in cold drink raw materials, the surface of the mechanism is prone to residual materials after each discharge. These residues will gradually accumulate and solidify, which not only easily breed bacteria and seriously threaten food safety, but also generate huge movement resistance, resulting in heavy user operation feel and even mechanism jamming, greatly shortening the service life of the equipment and reducing the user experience. Another type is a triple-link rotating mechanism, which can achieve smooth discharge action and effectively avoid the resistance problem caused by material residue through the synergistic effect of two rotating components and the connection rod, thereby improving the user experience. However, the complex transmission structure leads to a significant increase in the number of parts and a significant increase in assembly accuracy requirements, directly causing an increase in manufacturing costs. At the same time, the complex structure also increases the difficulty and cost of later maintenance, which is not conducive to the large-scale popularization of equipment.

Finally, the installation method of the condenser constrains production efficiency. The installation of the condenser in traditional shaved ice machines relies on screw fixation. During assembly, the screw holes on the condenser and equipment frame need to be aligned one by one, and then the fasteners need to be tightened one by one with the help of tools. The entire installation process is cumbersome and time-consuming, especially in mass production scenarios, which easily reduces the overall assembly efficiency of the shaved ice machine, increases the production time and labor costs of the enterprise, and is difficult to meet the efficient needs of large-scale production.

The purpose of the present disclosure is to provide a well-designed new type shaved ice machine that can address the deficiencies and shortcomings of existing technology.

To achieve the above objectives, the present disclosure provides the following technical solution: a shaved ice machine, including: an installation shell, where a tail of the installation shell is provided with a locking component, the installation shell is provided with an installation groove, and a detachable loading bucket is provided inside the installation groove; the loading bucket is connected to the locking component, and a front of the loading bucket is provided with a discharge component; the installation shell is provided with a stirring component, and the stirring component is provided inside the loading bucket; a front bottom of the installation shell is provided with a front panel, and the front panel is provided with a control panel; a bottom of the front panel is provided with a machine base, and the machine base is provided with a refrigeration component, two sides of the installation shell and two sides of the machine base are both provided with side heat dissipation plates, and a back of the installation shell and a back of the machine base are both provided with rear heat dissipation plates.

In some embodiments of the present disclosure, an inner bottom surface of the installation groove is inclined, and a drainage recess is provided on a lower side of the inner bottom surface of the installation groove; a drainage hole is provided in a middle of the drainage recess, and a drainage pipe is provided at a bottom of the drainage hole; a guide tube is provided at a top of the machine base corresponding to a position of the drainage pipe, and an insertion groove is provided at a front of the machine base; the guide tube is comminated to the insertion groove, and a front of the front panel is provided with a water-receiving tray, and one side of the water-receiving tray is inserted into the insertion groove.

In some embodiments of the present disclosure, guide grooves are symmetrically provided on inner walls of two sides of the installation groove, a pair of guide blocks are horizontally provided on two sides of the loading bucket corresponding guide grooves, a discharge port is provided on one side of the loading bucket, and installation plates are symmetrically provided on two sides of the discharge port; the discharge component is provided between two installation plates, and a dust cover is provided on the same side of the loading bucket; the dust cover is provided on an outer side of the two installation plates, and one side of the loading bucket away from the discharge component is welded with a bucket cover; triangular ribs are provided on an edge of one side of the loading bucket that is close to the bucket cover; the bucket cover is provided with a concave docking groove at a position corresponding to the triangular ribs, and the triangular ribs are provided in the concave docking groove; an outer wall of one side of the loading bucket that is close to the bucket cover is provided with a plurality of clamping grooves, and a convex block is provided on one side of the bucket cover at a position corresponding to the clamping grooves; the convex block is inserted into the clamping grooves, and a feeding cover is provided on one side of a top of the loading bucket.

In some embodiments of the present disclosure, a pair of first shaft blocks are symmetrically provided on outer walls of two sides of the installation shell, and the two first shaft blocks are respectively provided at a rear of the two guide grooves; a pair of second shaft blocks are also symmetrically provided on outer walls of two sides of the installation shell, and the two second shaft blocks are respectively provided at rears of the two first shaft blocks; a limit rod is provided above each of the second shaft blocks.

In some embodiments of the present disclosure, the locking component includes an inverted U-shaped handle, bottoms of two sides of the inverted U-shaped handle are symmetrically provided with turntable; the turntables are movable on the second shaft blocks, and an arc groove is provided on the turntables; the limit rod is provided inside the arc groove; a pair of first transmission plates are symmetrically provided at front ends of the turntables, and a pin rod is provided between the two first transmission plates; locking hooks are movable on the two first shaft blocks, and a tail of the locking hooks is provided with a second transmission plate; an upper of the second transmission plate is provided with a movable groove, and the pin rod is provided inside the movable groove; a pair of convex platforms are symmetrically provided on two sides of the loading bucket corresponding to positions of the locking hooks.

In some embodiments of the present disclosure, the discharge component includes a toggle handle, a bottom of the toggle handle is provided with an inverted L-shape abutting plate, a bottom of the inverted L-shape abutting plate is provided with a pair of fixing plates, two second shaft rods are provided between the two fixing plates, and fixing cylinders are simultaneously provided at tops of the two fixing plates, first shaft rods are symmetrically provided on two sides of the fixing cylinder; underneath the two fixing plates, there is a feeding port push plate, and a front of the feeding port push plate is provided with a sealing plug; a top of the feeding port push plate is provided with a third shaft rod, and a back of the third shaft rod is provided with a transmission component, and the transmission component is provided with an elliptical groove; the transmission component is provided between the two fixing plates, and the second shaft rod is movable in the elliptical groove; the first shaft rod and the third shaft rod are both movable between the two installation plates; two sides of the fixing cylinder are simultaneously sleeved with torsion springs, and one side of the torsion springs is pressed against a bottom of the inverted L-shape abutting plate, the other side of the torsion springs is supported on an outer wall of the loading bucket and provided above the discharge port.

In some embodiments of the present disclosure, the stirring component includes a fixing circular plate provided on a back of the installation groove, and a front of the fixing circular plate is fixed with a cold guide cylinder through a plurality of screws; the cold guide cylinder is provided in the installation groove, and a sealing bearing is provided in a wall of the cold guide cylinder on one side away from the fixing circular plate; a back of the fixing circular plate is provided with a driving reducer, and a transmission shaft is provided on a transmission end of the driving reducer; the transmission shaft is provided inside the cold guide cylinder, with one end provided inside the sealing bearing, an outer side of the cold guide cylinder is sleeved with a base, and the base is provided with a plurality of support rods; a pair of spiral blades are simultaneously wound around outer sides of the plurality of support rods, and each of the spiral blades is provided with a discharge plate at a top; a connection sleeve is provided between top ends of the two discharge plates, and the connection sleeve is provided at a top of the transmission shaft; a sealing gasket is provided on an inner wall of the installation groove, and the sealing gasket is provided on an outer side of the cold guide cylinder, and the bucket cover is pressed against the sealing gasket; the discharge plate is a narrow front and wide rear structure, and a pair of convex points are provided at a top of the connection sleeve.

In some embodiments of the present disclosure, a top of the machine base is provided with a plurality of limit rings, each of the limit rings is provided with an installation column, one side of the machine base is provided with a square groove, and one side of a top of the machine base is further provided with a pair of U-shaped ribs.

In some embodiments of the present disclosure, the refrigeration component includes a compressor provided on the machine base, and connection plates are symmetrically provided on two sides of a bottom of the compressor; the connection plates are provided with docking foot sleeves at positions corresponding to a plurality of installation columns, and the docking foot sleeves are inserted into the limit rings and sleeved on outsides of the installation columns; the installation columns and the docking foot sleeves are fixed by screws, and a fan bracket is provided on one side of the compressor, a bottom of the fan bracket is provided with a pair of installation feet, and two installation feet are respectively provided in two square grooves, and the square grooves and the installation feet are fixed by screws; an air duct is provided inside the fan bracket; an installation bracket is provided on a front of the air duct, and a plurality of screw holes are provided on the installation bracket; a back of the installation bracket is provided with a plurality of semi-circular bone positions, and the plurality of semi-circular bone positions are respectively provided on one side of the plurality of screw holes; the back of the installation bracket is further provided with a fan motor, and a fan body is provided on a transmission end of the fan motor; positions of the fan motor corresponding to the plurality of semi-circular bone positions are provided with a plurality of screw posts, the plurality of the screw posts are respectively provided in the plurality of semi-circular bone positions and fixed with screws; two sides of a back of the fan bracket are symmetrically provided with wind deflectors, and a condenser is provided between the two wind deflectors; a plurality of buckles are provided on four corners of the back of the fan bracket, and the condenser is clamped on the plurality of buckles; a drying filter is provided on the two U-shaped ribs, and an evaporator is provided inside the cold guide cylinder; the evaporator, compressor, condenser, and drying filter are sequentially connected through copper pipes.

Compared with the existing technology, the above technical solution of the present disclosure has the following beneficial technical effects.

1. The loading bucket of the present disclosure is provided with the guide blocks and the guide groove that are sliding cooperation, and the locking component driven by the inverted U-shaped handle. Only by pushing the loading bucket and turning the handle can the locking or unlocking be completed. Compared with the traditional fixed installation structure, the loading bucket can be quickly disassembled, greatly reducing the cleaning, maintenance, and raw material replacement time. At the same time, the inclined bottom surface of the installation groove, the drainage groove, and the water-receiving plate form a complete condensate collection system, which can guide and collect the condensate water generated by the loading bucket and the installation shell in a directional manner, avoiding the pollution of the environment or the damage of equipment caused by condensate water droplets, and balancing practicality and environmental cleanliness.

2. The discharge component of the present disclosure is designed in coordination with the shaft rod, transmission parts, and torsion spring. By pressing and turning the handle, the sealing plug can be driven to detach from the discharge port. After releasing the handle, the torsion spring automatically drives the component to reset, which not only avoids the problem of sticking caused by residual materials in the double link mechanism and ensures smooth operation, but also eliminates the need for complex transmission parts of the triple-link rotating mechanism, reducing the number of parts and assembly accuracy requirements. This design not only improves user experience and food safety, but also effectively controls manufacturing costs, reduces maintenance difficulty in the later stage, and is more conducive to the large-scale popularization of equipment.

3. In the refrigeration component of the present disclosure, the compressor is quickly positioned by the docking foot sleeve and the limit ring, the fan bracket installation feet are directly embedded in the square grooves, and the condenser is clamped in the buckles. Compared with the traditional screw fixing method, there is no need to align the screw holes one by one and tighten them with tools, significantly simplifying the installation process of the condenser and other components, and greatly improving the assembly efficiency during mass production.

4. In the stirring component of the present disclosure, the spiral blades rotate synchronously with the discharge plate, which not only achieves full crushing and mixing of materials, but also guides the directional flow of smoothie through the narrow front and wide back structure of the discharge plate, and cooperates with the cool guide tube to uniformly conduct low temperature, ensuring that the produced smoothie are evenly distributed and have a delicate taste, and comprehensively guaranteeing the quality of cold drinks.

5. The present disclosure provides a pair of convex points at the top of the connection sleeve, which contacts the inner wall of the loading bucket to reduce the contact area between the top of the discharge plate and the loading bucket. This can prevent smoothies from freezing the mixing blade and reduce the noise during the rotation of the mixing blade.

### BRIEF DESCRIPTION OF DRAWINGS

FIG. 1 is a schematic diagram of an overall structure of the present disclosure.

FIG. 2 is a schematic structural diagram of the present disclosure when a side heat dissipation plate and a rear heat dissipation plate being removed.

FIG. 3 is a schematic structural diagram of an installation shell of the present disclosure.

FIG. 4 is a schematic structural diagram of the installation shell and a stirring component being assembly of the present disclosure.

FIG. 5 is a schematic structural diagram of FIG. 4 from a lower rear perspective.

FIG. 6 is a schematic structural diagram of a stirring component of the present disclosure.

FIG. 7 is a schematic structural diagram of a loading bucket and a discharge component during assembly of the present disclosure.

FIG. 8 is a schematic structural diagram of the loading bucket of the present disclosure.

FIG. 9 is a schematic structural diagram of the loading bucket when a buckle cover being unfolded of the present disclosure.

FIG. 10 is a front sectional structure view of FIG. 7.

FIG. 11 is an enlarged view of point A in FIG. 10.

FIG. 12 is a schematic structural diagram of the loading bucket when a dust cover being removed of the present disclosure.

FIG. 13 is a schematic structural diagram of a discharge component of the present disclosure.

FIG. 14 is a schematic diagram of a discharge component being unfolded of the present disclosure.

FIG. 15 is a schematic structural diagram of a locking component in a locked state of the present disclosure.

FIG. 16 is a schematic structural diagram of the locking component in an unlocked state of the present disclosure.

FIG. 17 is a schematic structural diagram of the locking component of the present disclosure.

FIG. 18 is a schematic diagram of the locking component being unfolded of the present disclosure.

FIG. 19 is a schematic structural diagram of a refrigeration component and a machine base being assembly of the present disclosure.

FIG. 20 is a schematic structural diagram shown in FIG. 19 from another side view.

FIG. 21 is a schematic structural diagram of a fan bracket and a condenser being assembly of the present disclosure.

FIG. 22 is a schematic structural diagram of the fan bracket of the present disclosure.

FIG. 23 is a schematic structural diagram of the fan bracket and a fan motor of the present disclosure.

FIG. 24 is a schematic structural diagram of the machine base of the present disclosure.

FIG. 25 is a schematic structural diagram of the machine base and a compressor being assembly of the present disclosure.

FIG. 26 is a schematic structural diagram of the machine base and compressor being deployed of the present disclosure.

FIG. 27 is a schematic diagram of a bottom perspective structure of the machine base of the present disclosure.

Numeral reference: installation shell 1, front panel 10, installation groove 11, guide groove 12, drainage recess 13, drainage pipe 14, first shaft block 15, second shaft block 16, control panel 17, sealing gasket 18, drainage hole 19, limit rod 110, machine base 2, installation column 20, U-shaped rib 21, square groove 22, insertion groove 23, guide tube 24, connection plate 25, limit ring 26, docking foot sleeve 27, loading bucket 3, installation plate 30, discharge port 31, guide block 32, convex platform 33, bucket cover 34, triangular rib 35, concave docking groove 36, convex block 37, clamping groove 38, dust cover 39, feeding cover 310, locking component 4, inverted U-shaped handle 40, turntable 41, arc groove 42, first transmission plate 43, pin rod 44, locking hook 45, second transmission plate 46, movable groove 47, discharge component 5, toggle handle 50, inverted L-shape abutting plate 51, fixing cylinder 52, first shaft rod 53, fixing plate 54, second shaft rod 55, feeding port push plate 56, sealing plug 57, third shaft rod 58, transmission component 59, elliptical groove 510, torsion spring 511, refrigeration component 6, compressor 60, fan bracket 61, buckle 62, air duct 63, installation bracket 64, screw hole 65, semi-circular bone position 66, installation foot 67, fan body 68, fan motor 69, screw post 610, condenser 611, drying filter 612, evaporator 613, wind deflector 614, stirring component 7, driving reducer 70, fixing circular plate 71, cold guide cylinder 72, sealing bearing 73, transmission shaft 74, base 75, support rod 76, spiral blade 77, discharge plate 78, connection sleeve 79, convex point 710, water-receiving tray 8, side heat dissipation plate 9, rear heat dissipation plate 90.

### DESCRIPTION OF EMBODIMENTS

The following will provide a clear and complete description of the technical solution in the embodiments of the present disclosure, based on the accompanying drawings. Obviously, the described embodiments are only a part of the embodiments of the present disclosure, not all of them. Based on the embodiments in the present disclosure, all other embodiments obtained by those skilled in the art without creative work are within the protection scope of the present disclosure.

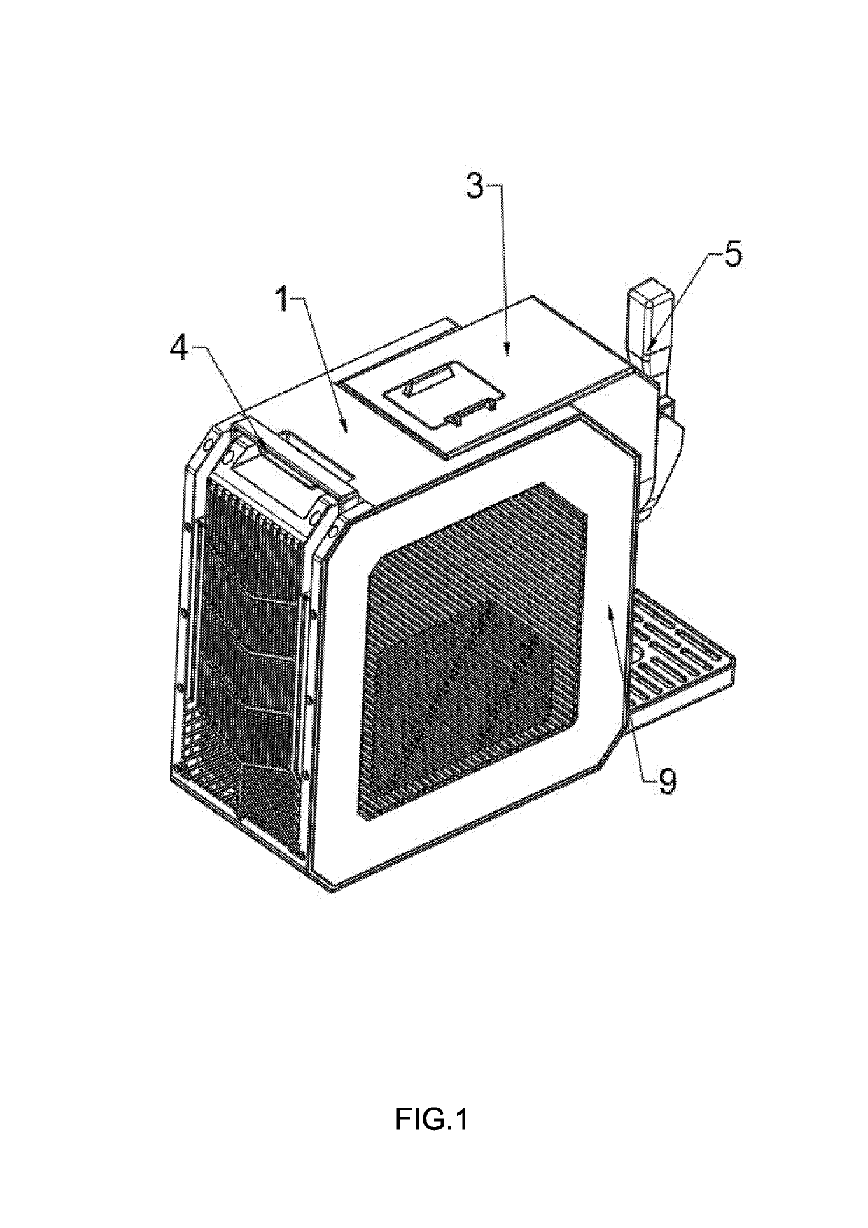

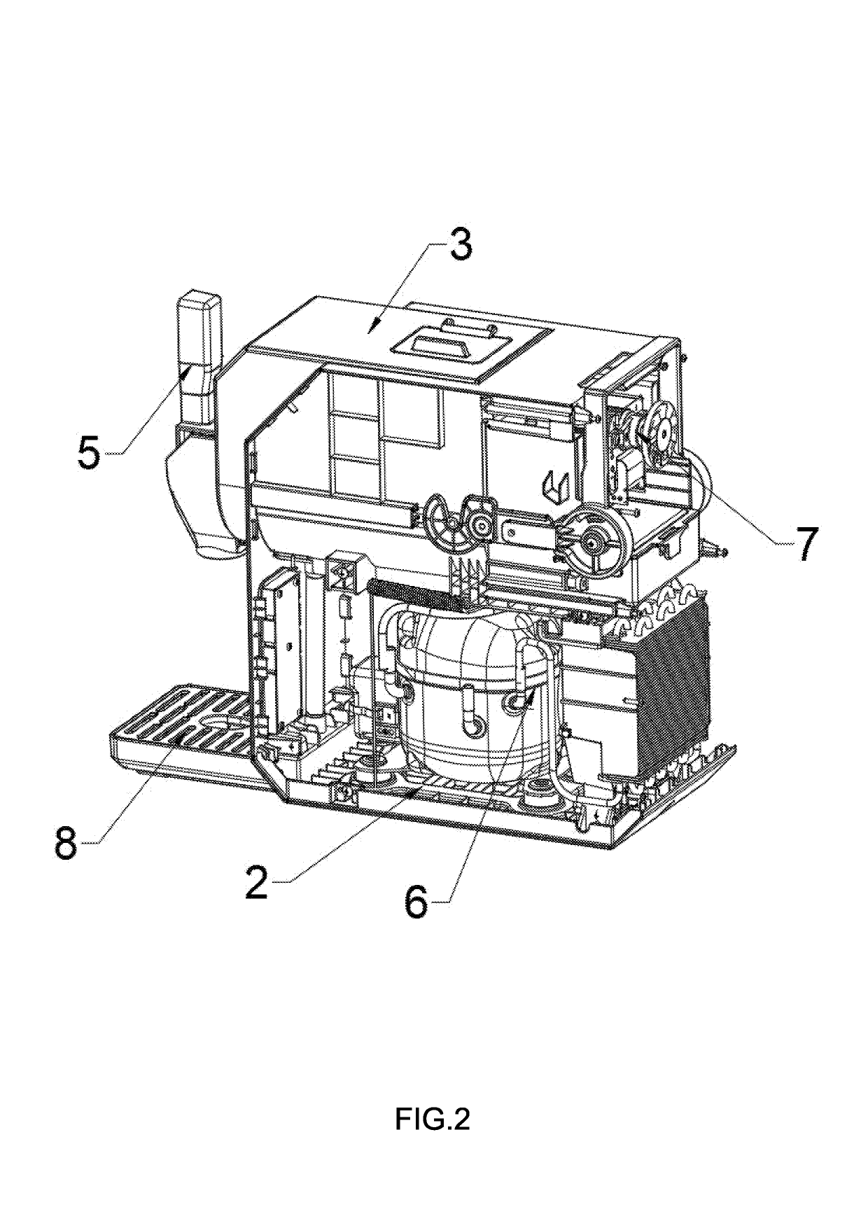

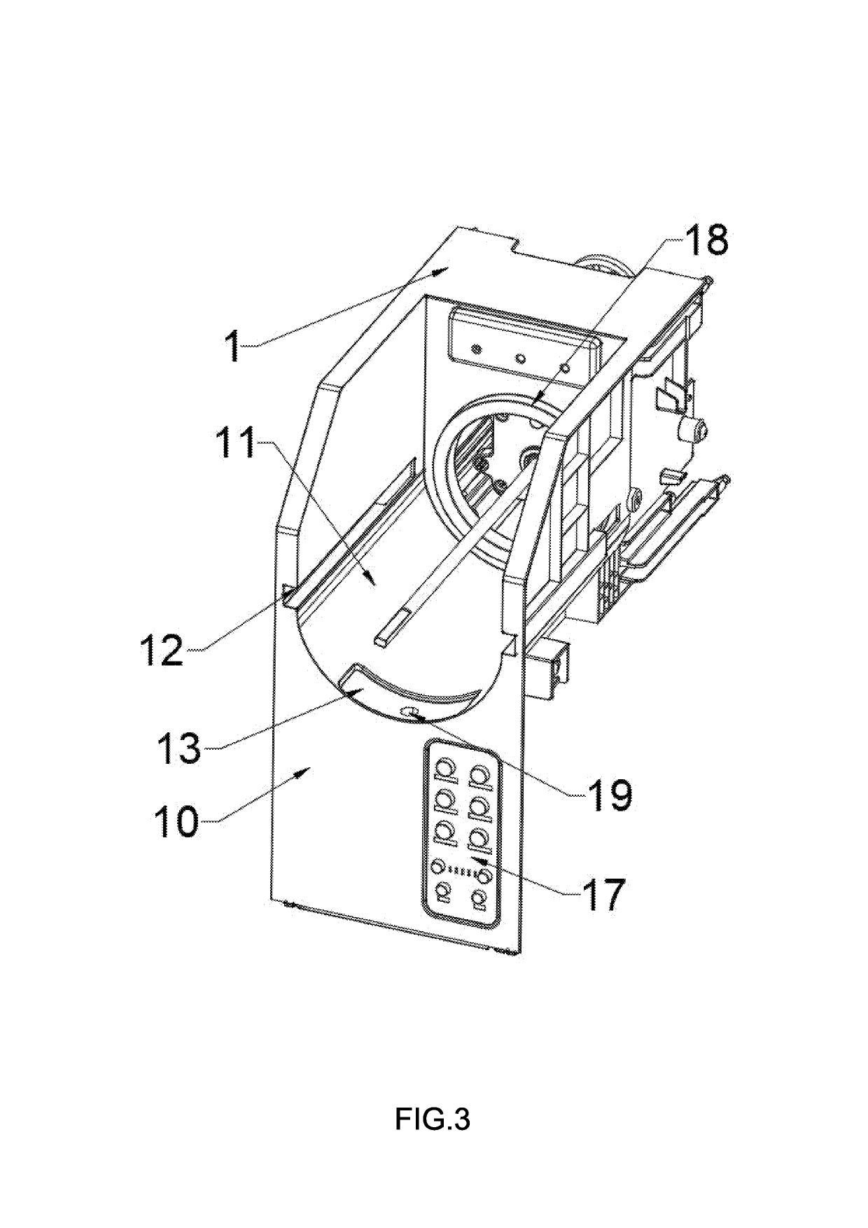

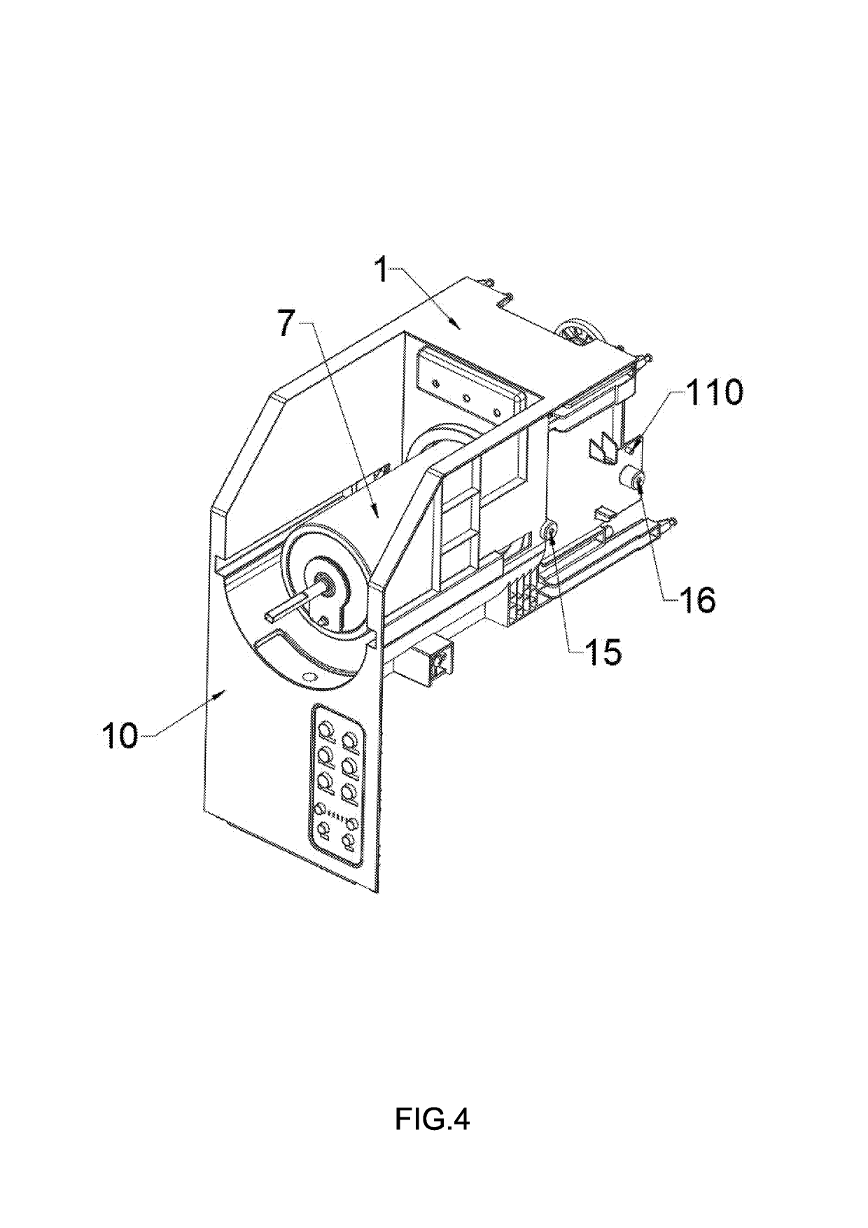

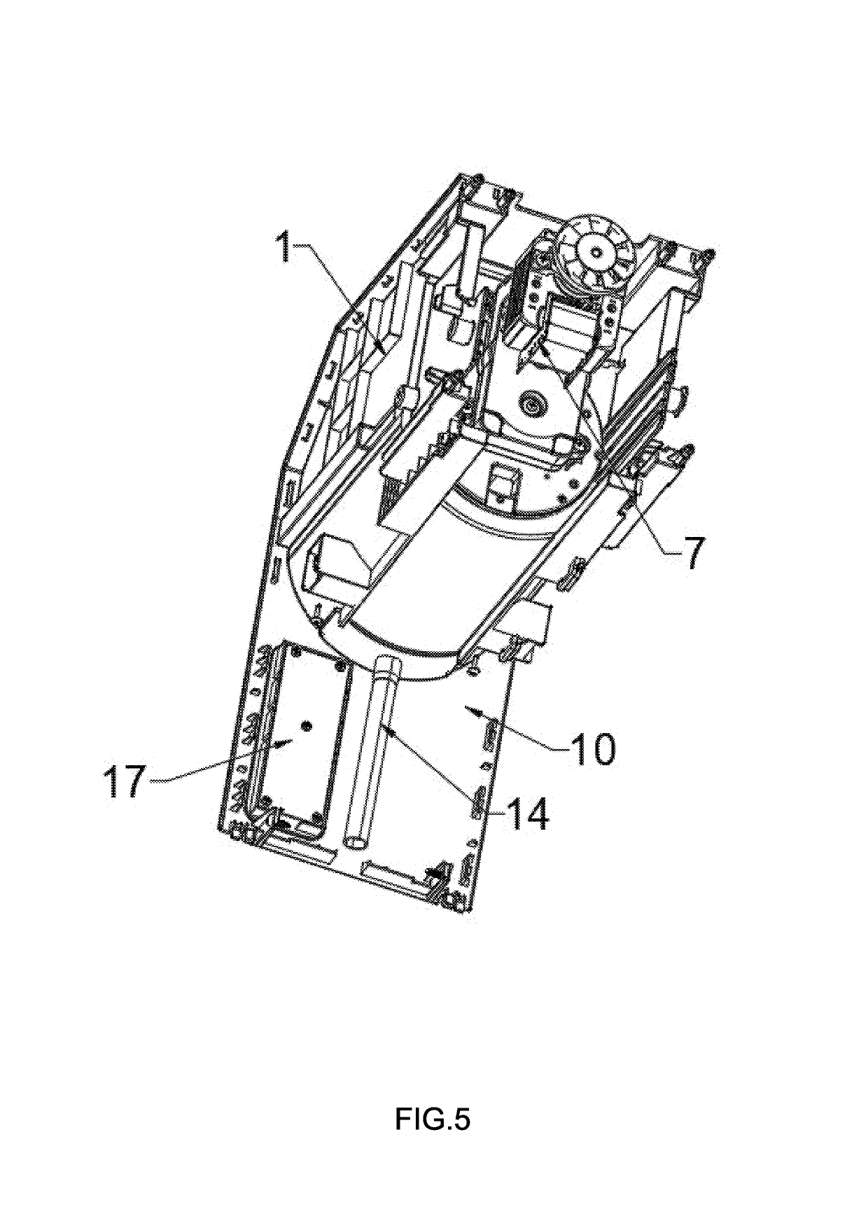

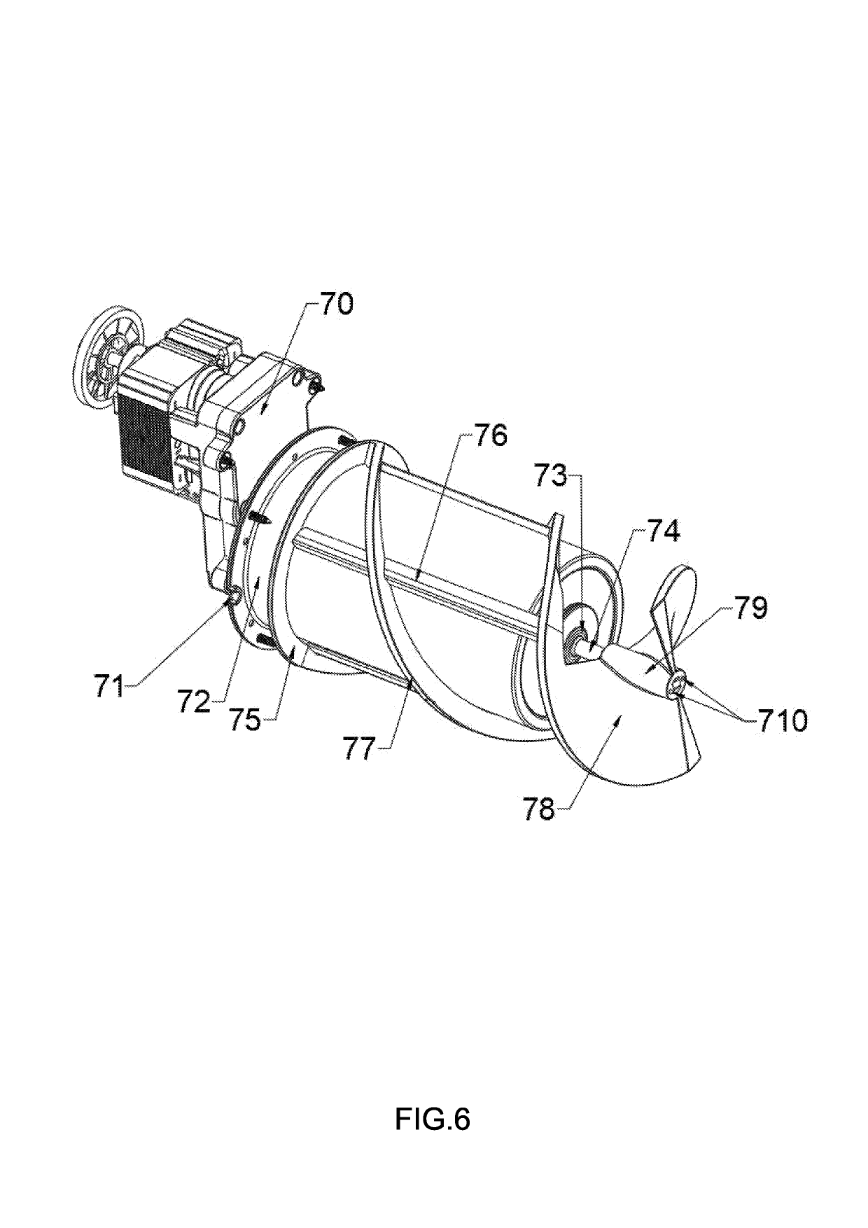

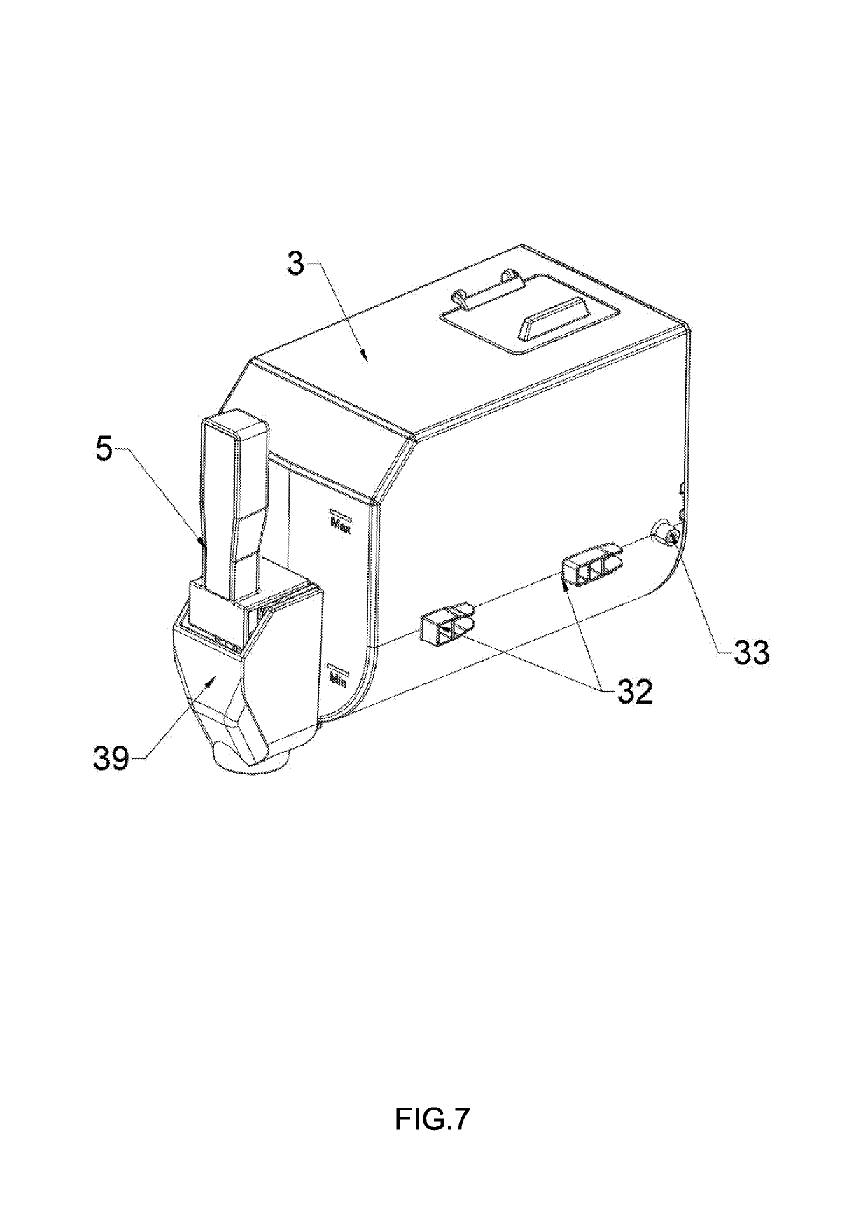

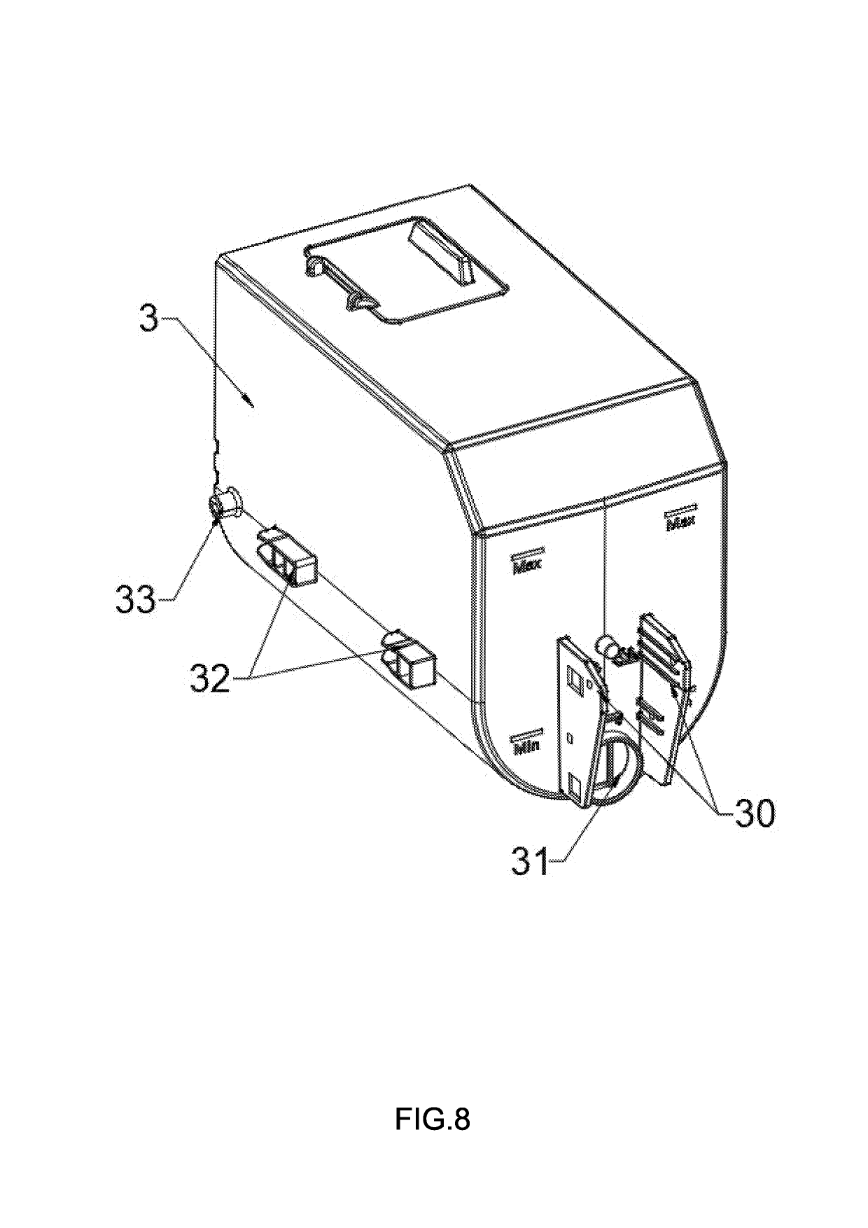

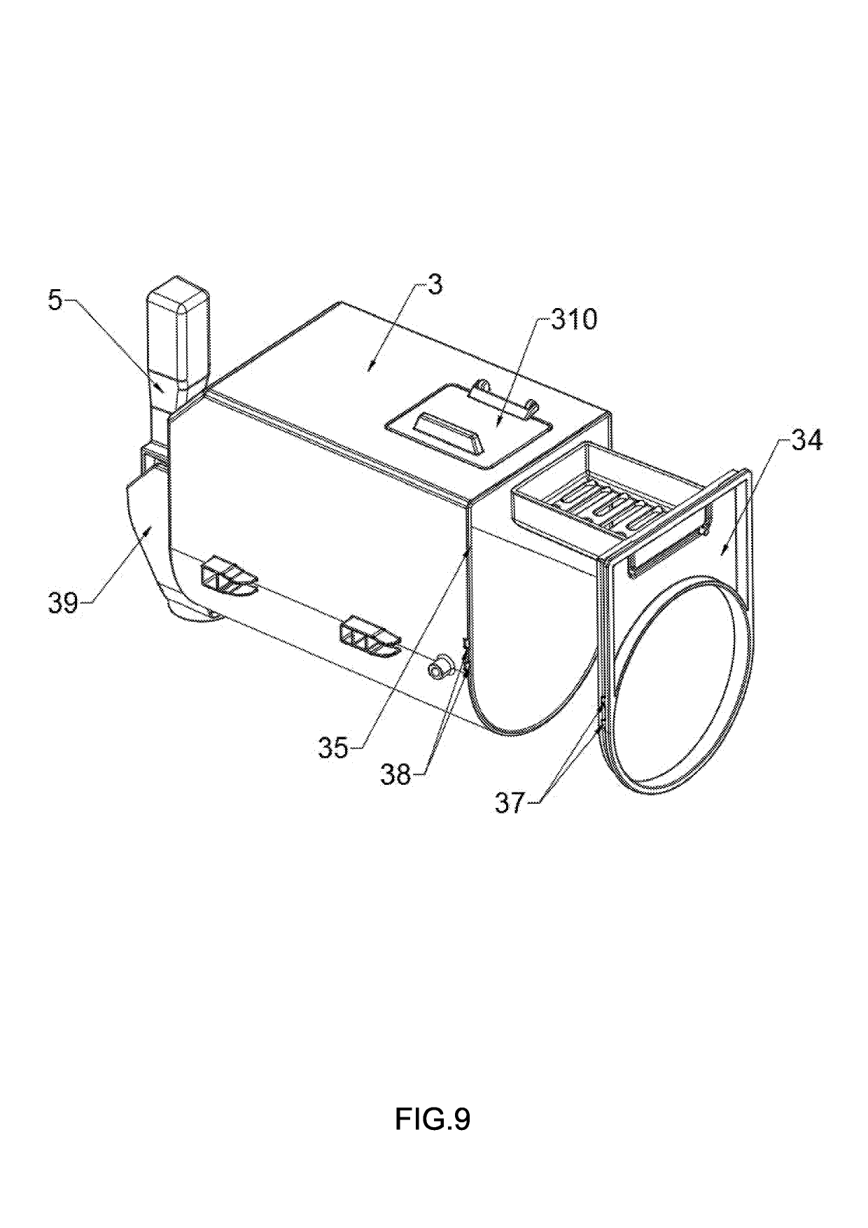

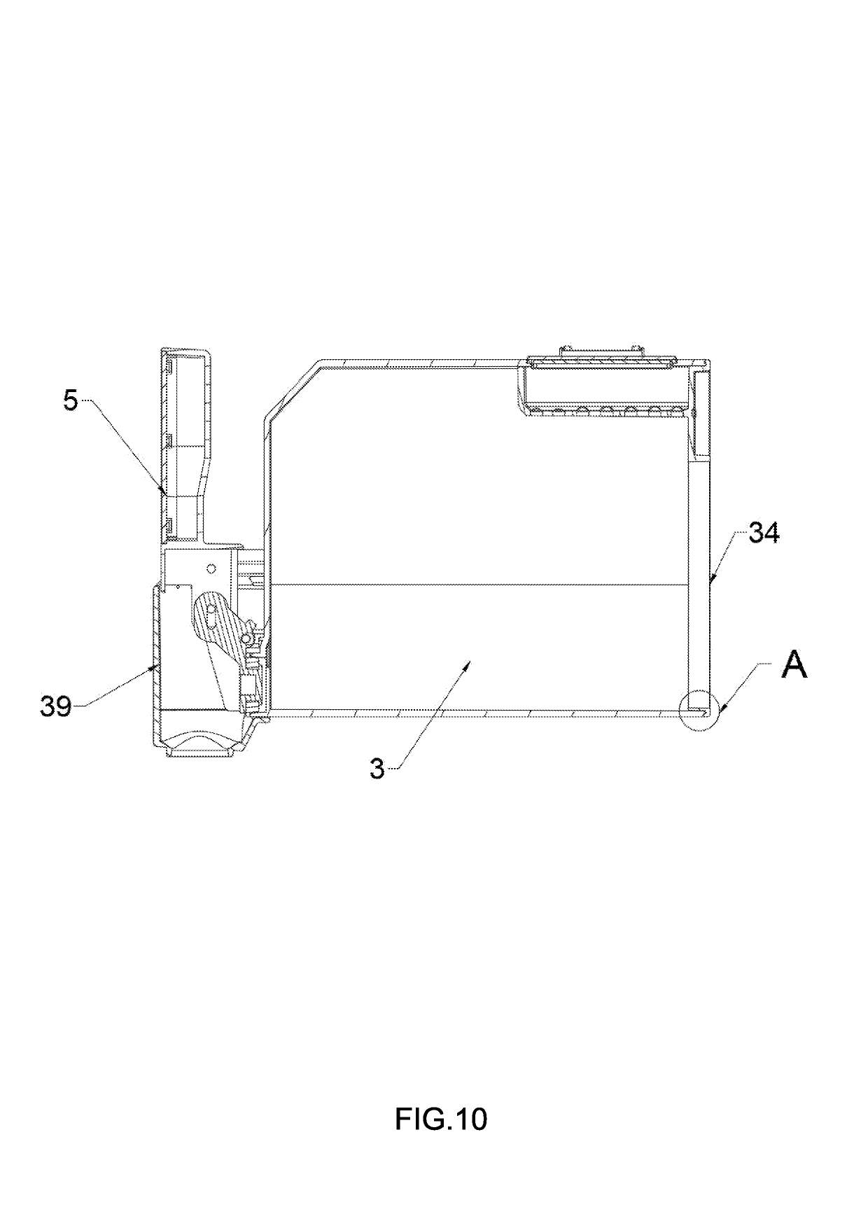

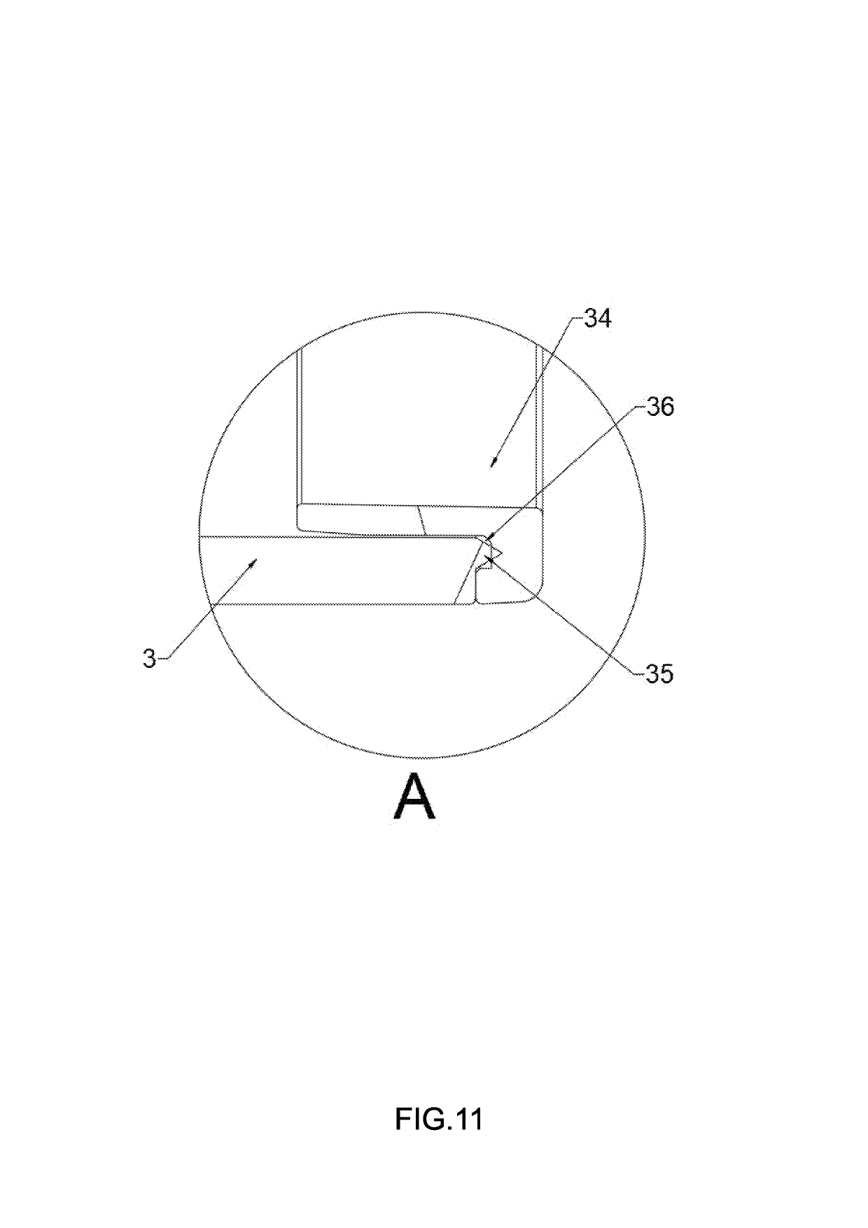

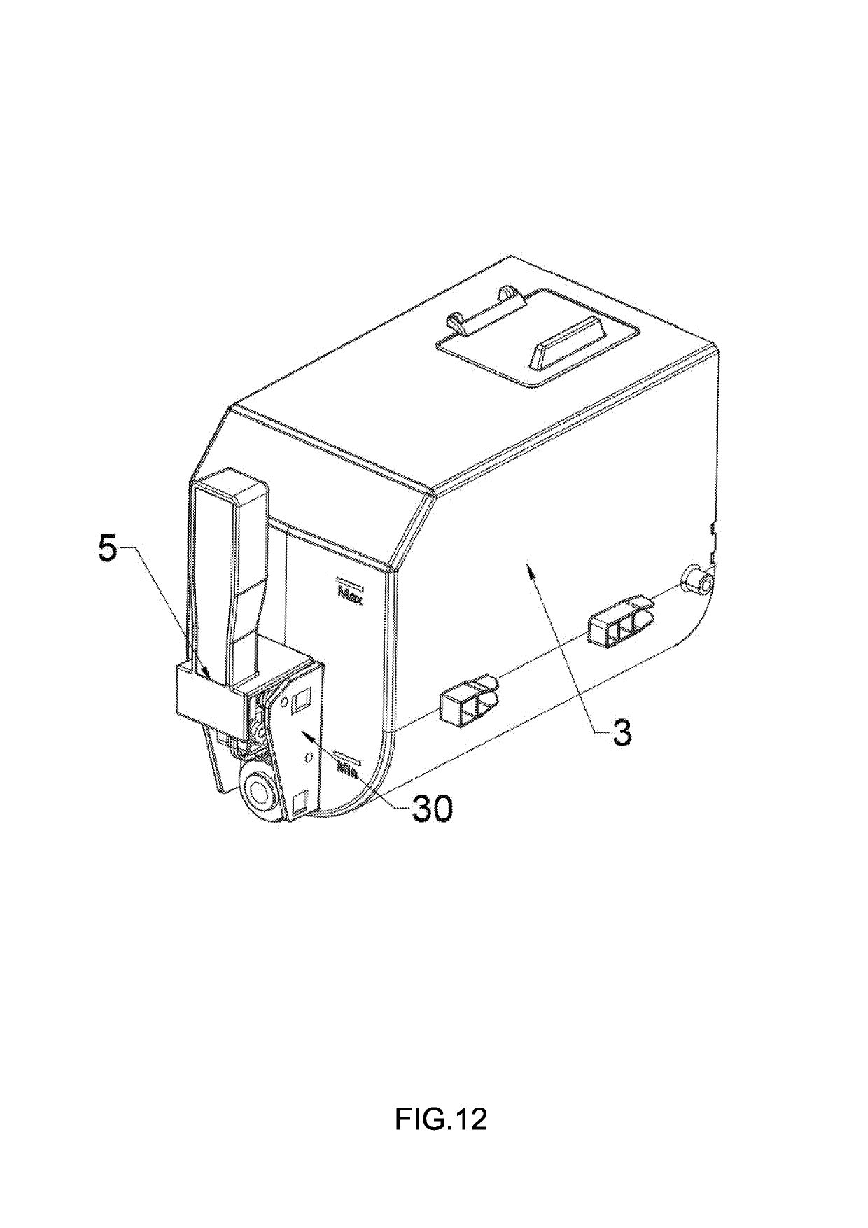

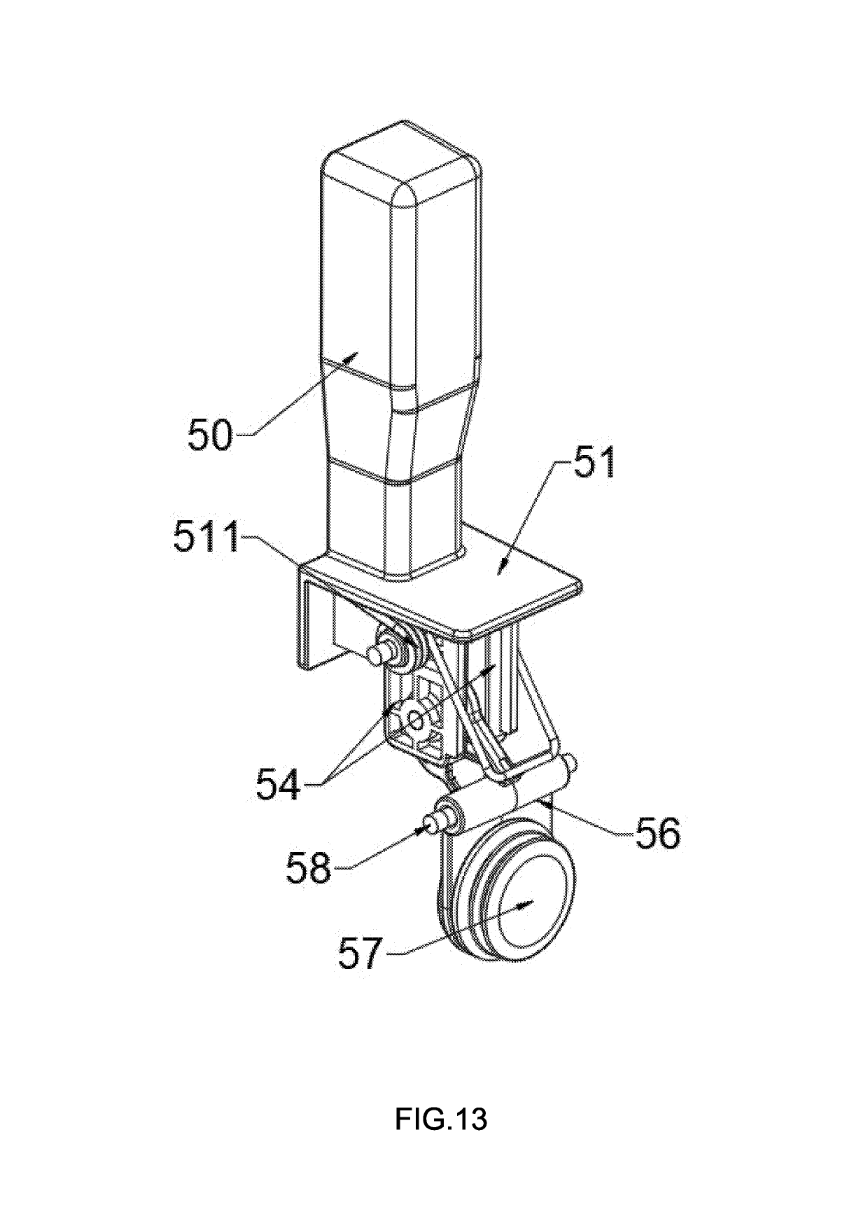

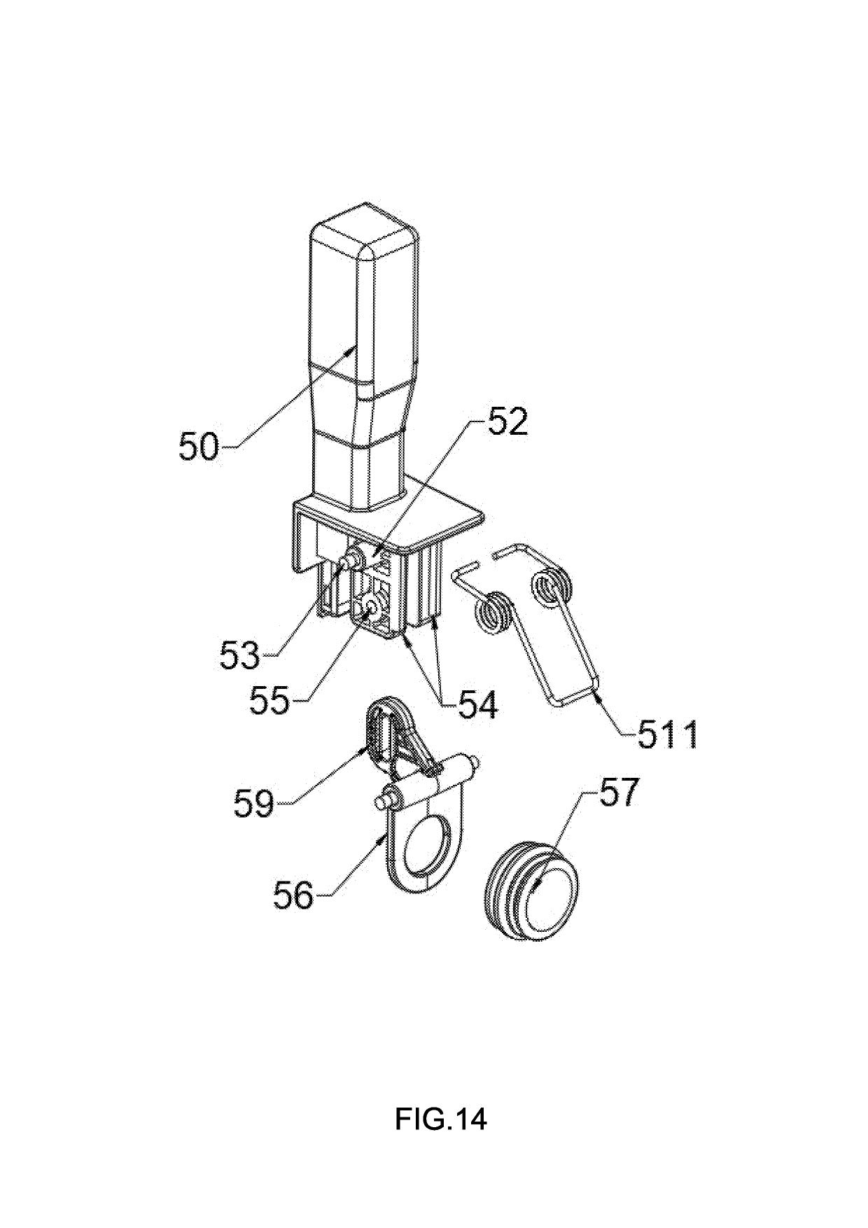

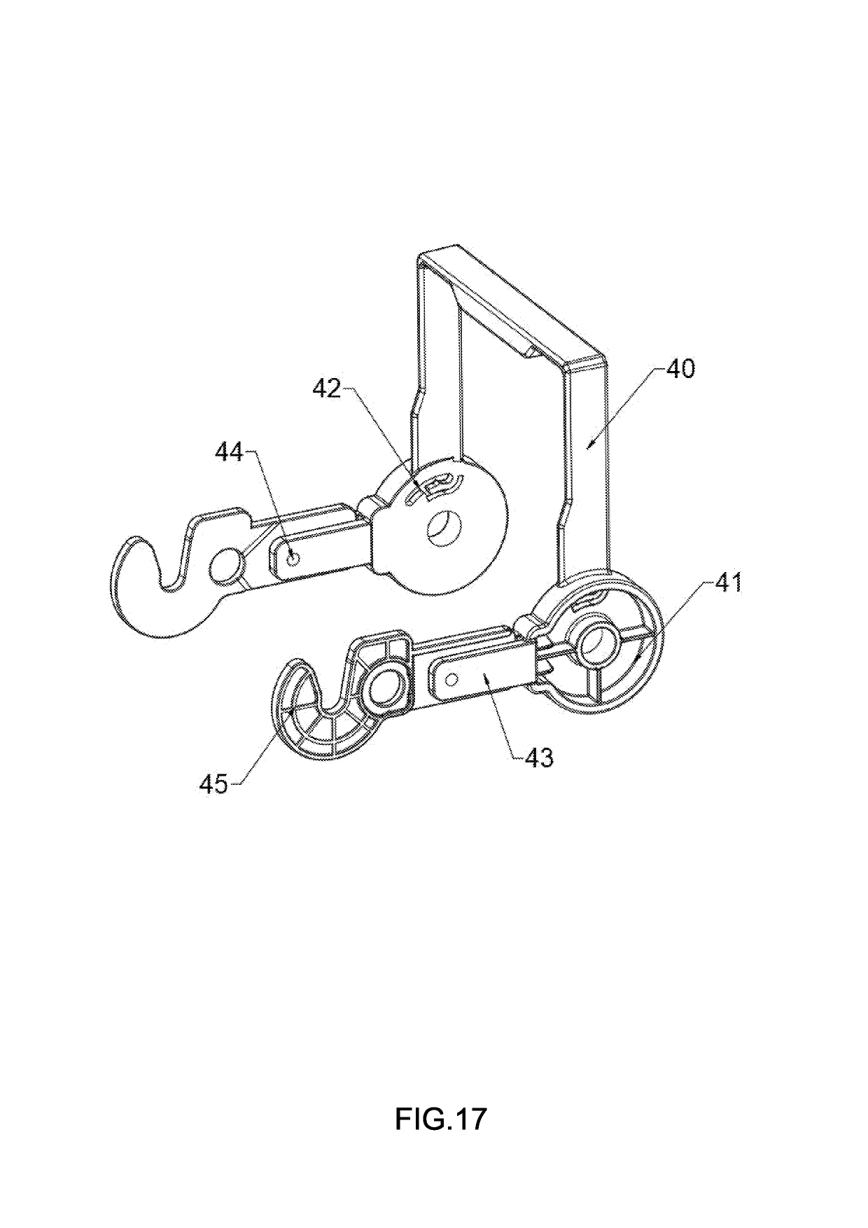

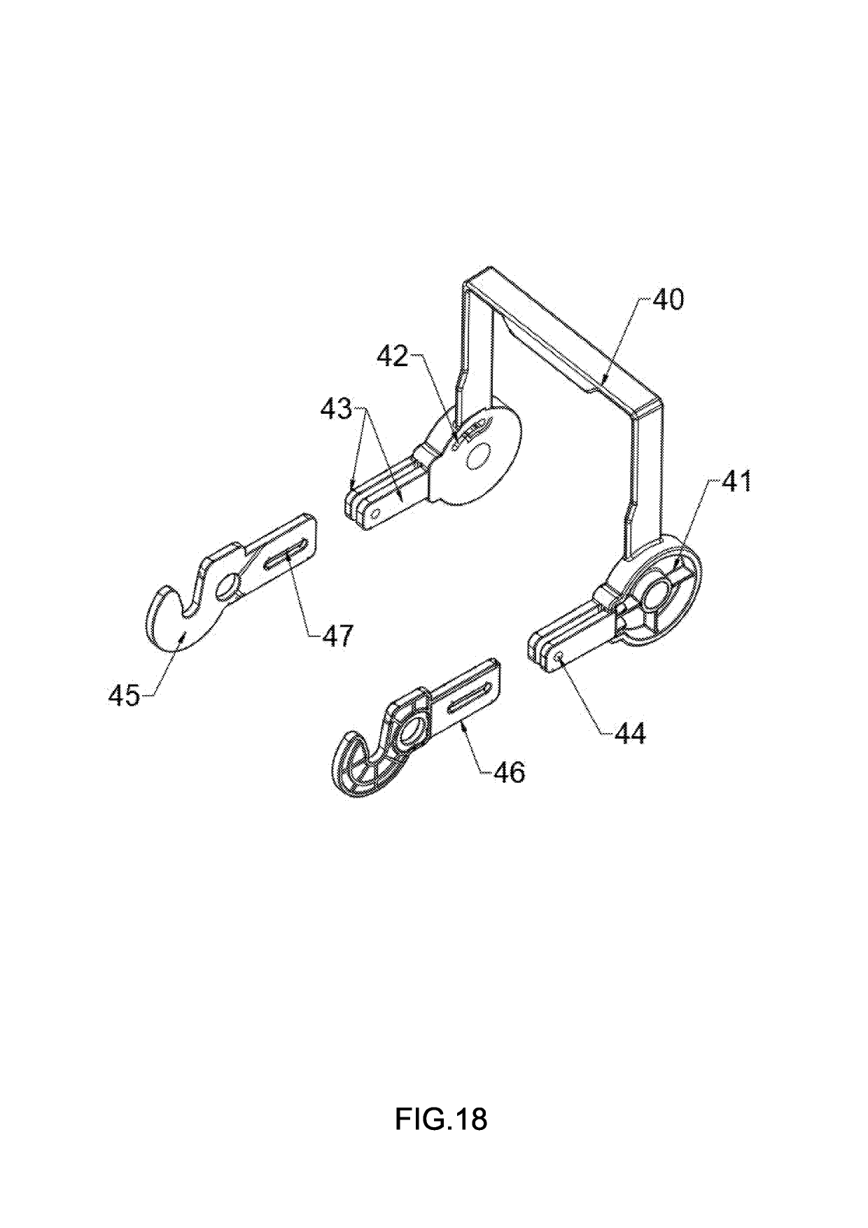

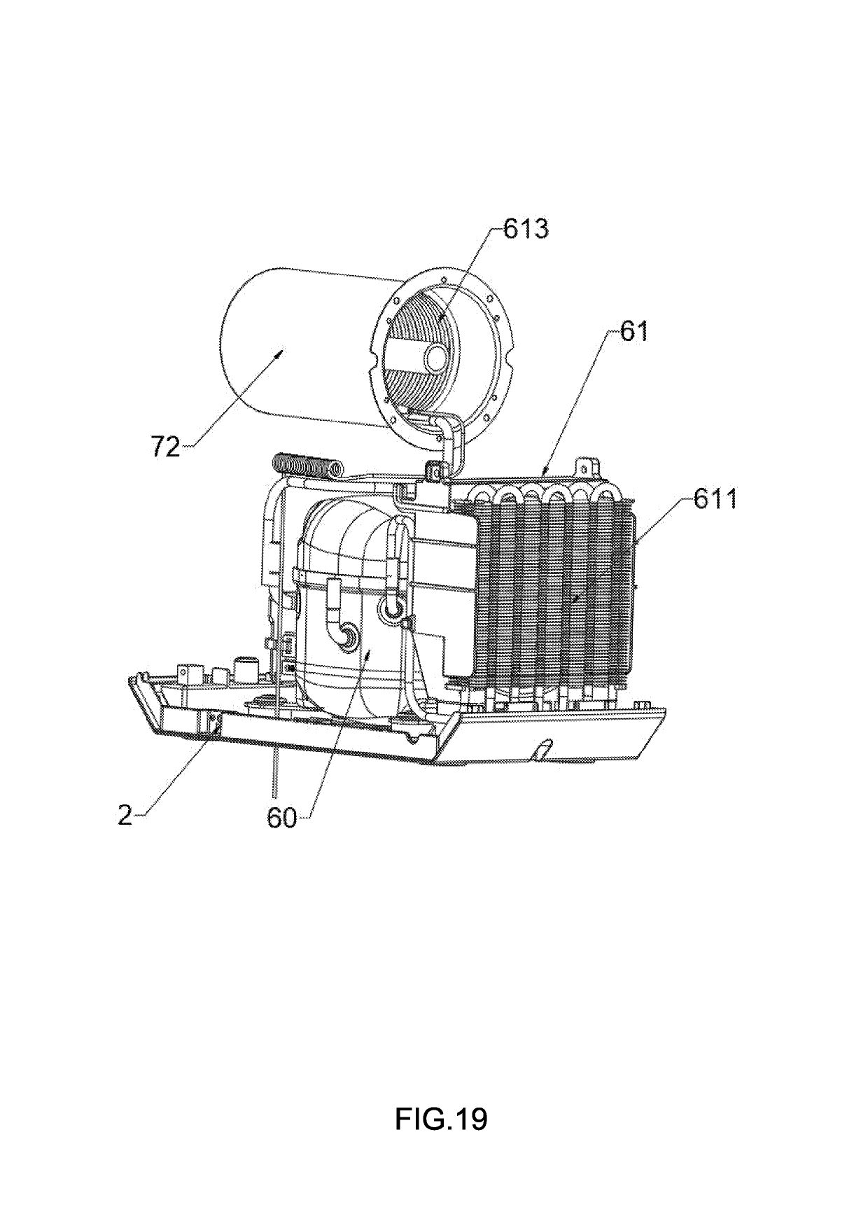

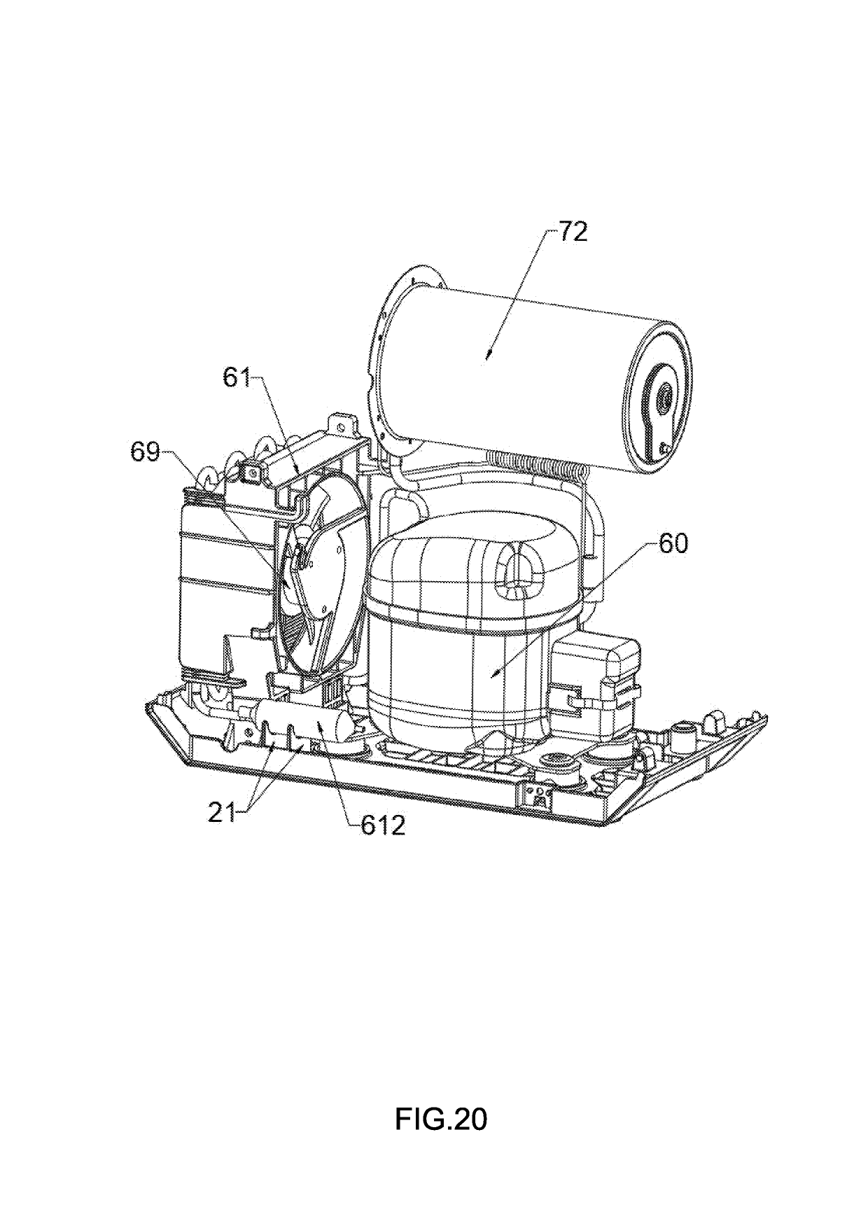

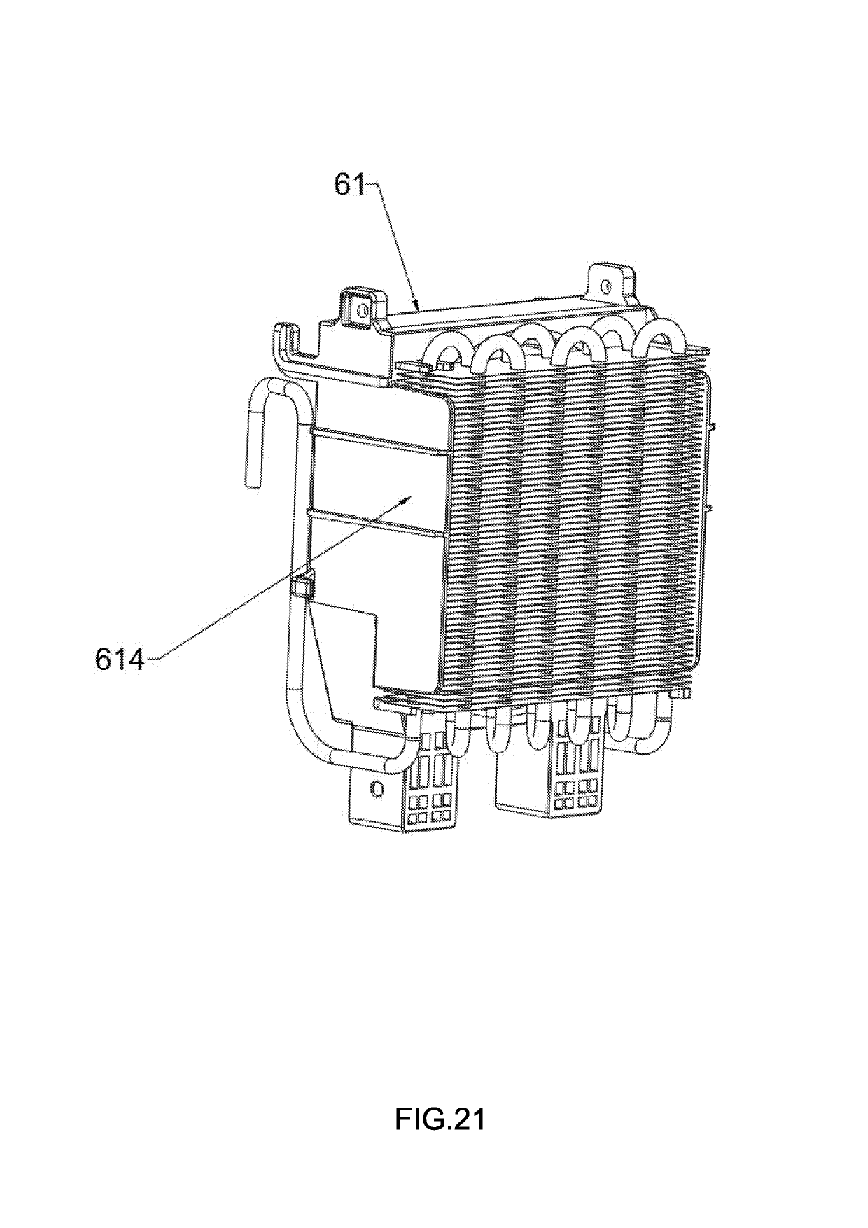

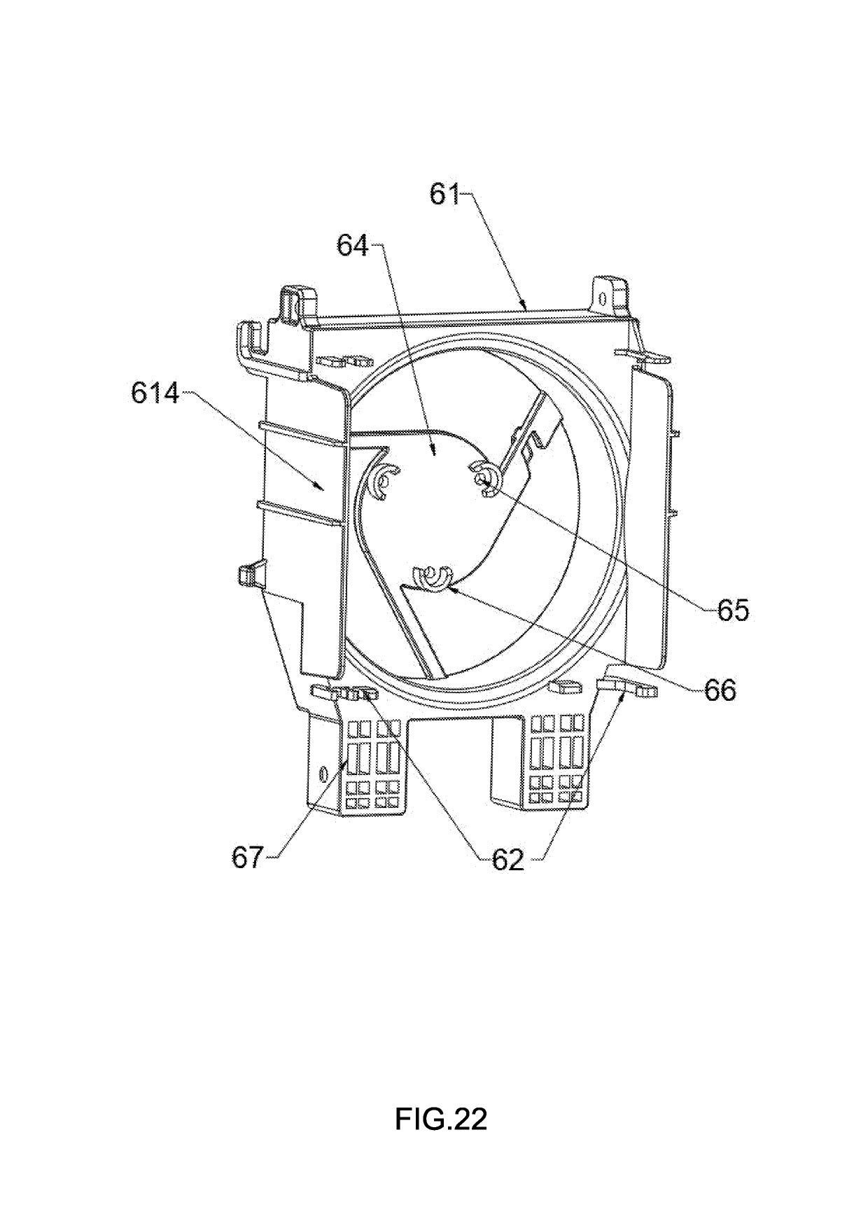

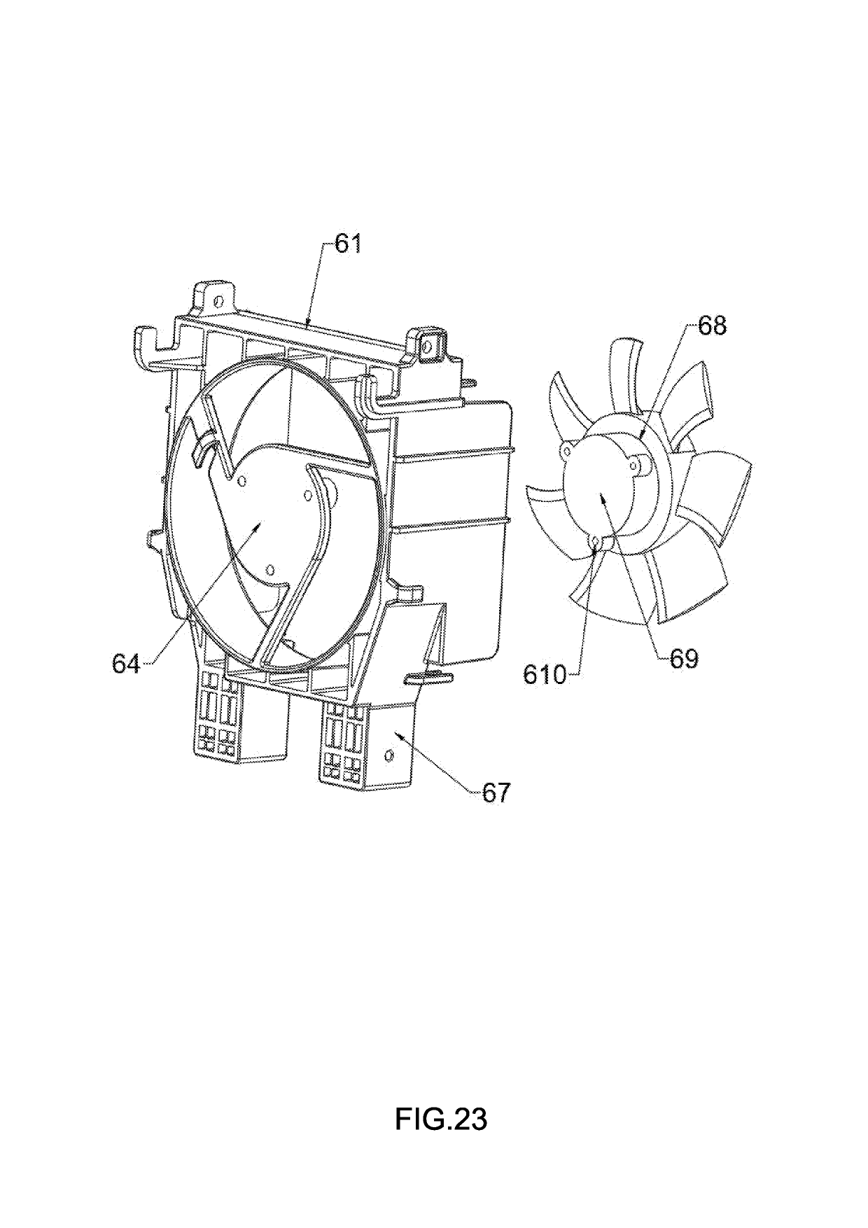

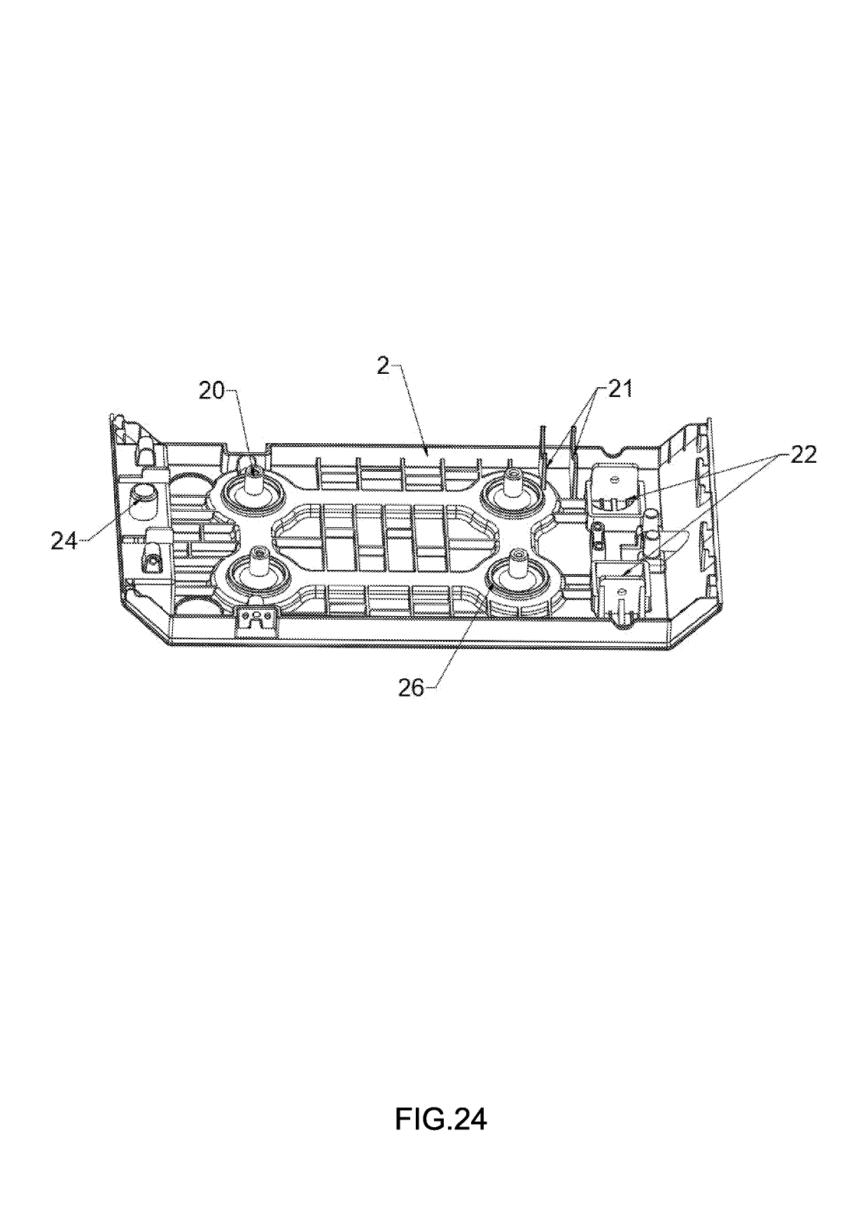

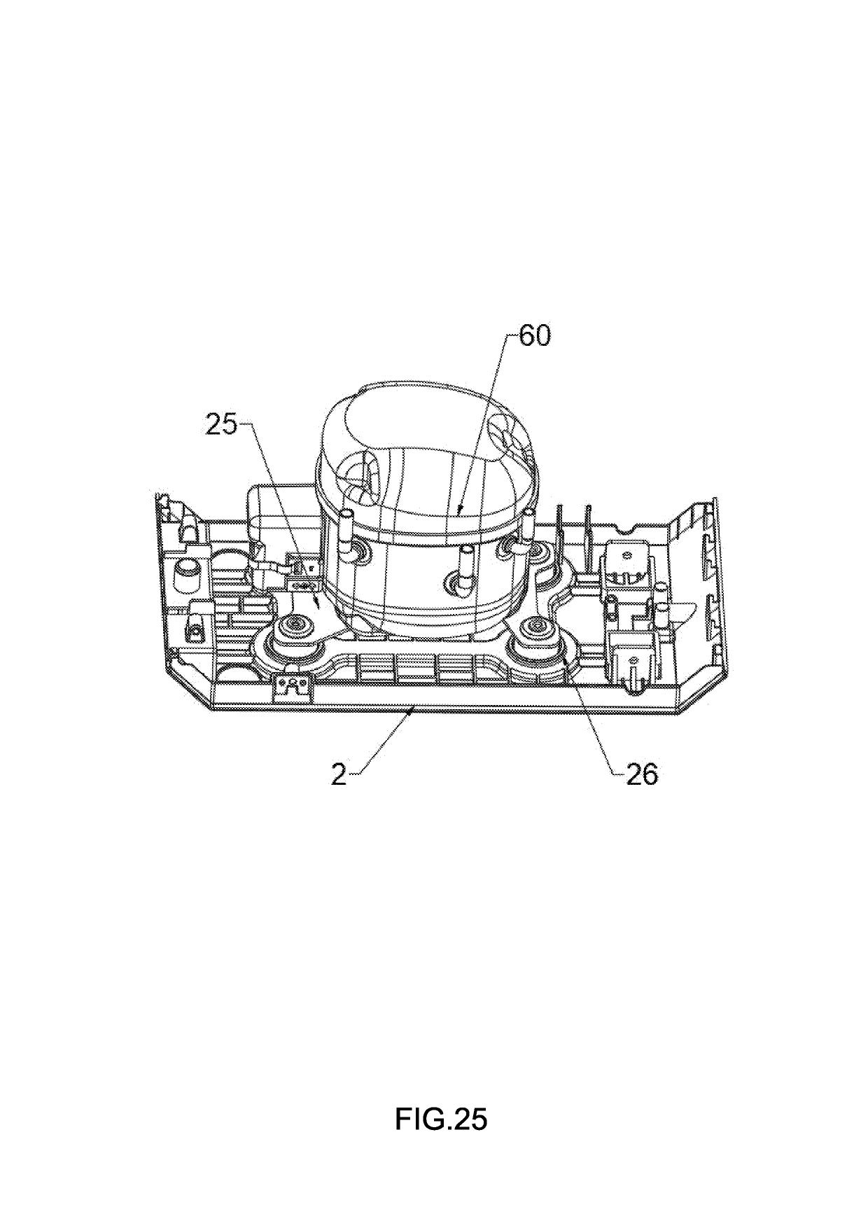

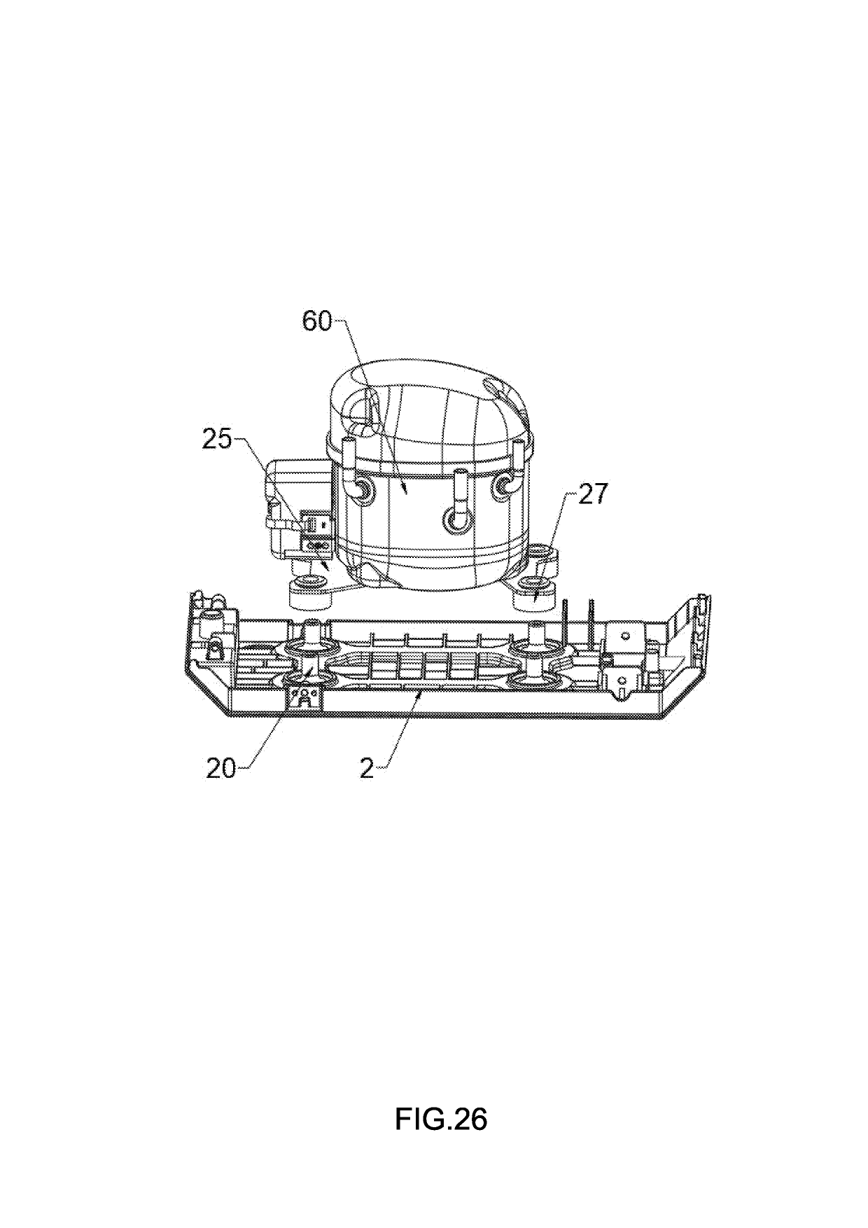

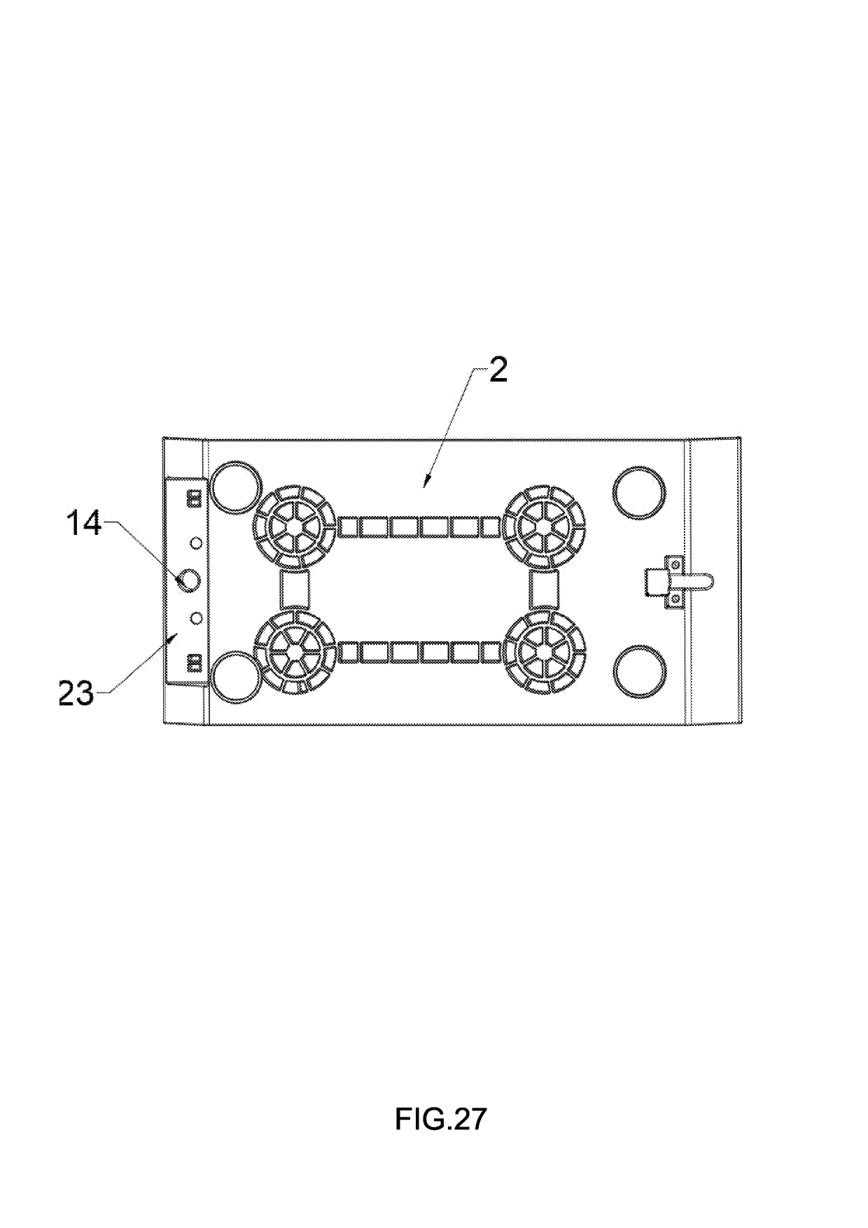

As shown in FIGS. 1-27, the present disclosure proposes a new type of shaved ice machine, which is fixedly connected by bolts between two main bodies of an installation shell 1 and a machine base 2.

An installation groove 11 is provided on a front of the installation shell 1 and symmetrically process guide grooves 12 are provided on two sides of the installation groove 11. Horizontal welding guide blocks 32 are provided on two sides of the loading bucket 3, and the guide blocks 32 slide and cooperate with the guide grooves 12 to achieve a detachable insertion of the loading bucket 3 into the installation groove 11. A bottom surface of the installation groove 11 is designed to be inclined, and a drainage recess 13 is provided on a low side. A middle of the drainage recess 13 passes through a drainage hole 19, and a drainage pipe 14 is provided at a bottom of the drainage hole 19. The drainage pipe 14 is aligned and connected with a guide tube 24 at a top of the machine base 2, and the guide tube 24 extends to the insertion groove 23 at a front end of the machine base 2. The insertion groove 23 is configured to insert a water-receiving tray 8.

On one side of the loading bucket 3, a bucket cover 34 is welded, and triangular ribs 35 are provided on an edge of a bucket body that fits the bucket cover 34. A concave docking groove 36 is provided at a corresponding position of the bucket cover 34, and the triangular ribs 35 are embedded in the concave docking groove 36 to achieve preliminary sealing. An outer wall of the bucket cover 34 is provided with a plurality of clamping grooves 38, and one side of the bucket cover 34 is provided with convex blocks 37. The convex blocks 37 are inserted into the clamping grooves 38 to strengthen the fixation. The sealing gasket 18 is pasted on an inner wall of the installation groove 11. After the loading bucket 3 is pushed in, the bucket cover 34 tightly contacts the sealing gasket 18, thus completing the sealing between the loading bucket 3 and the installation groove 11.

Outer walls on two sides of the installation shell 1 are symmetrically provided with first shaft blocks 15 and second shaft blocks 16 (the second shaft blocks 16 are provided behind the first shaft blocks 15), and a limit rod 110 is provided above the second shaft blocks 16. A bottom of two sides of the inverted U-shaped handle 40 on the locking component 4 is connected to a turntable 41 through a rotating shaft. The turntable 41 is movable and sleeved on the second shaft blocks 16. The turntable 41 is provided with an arc groove 42, and the limit rod 110 is embedded in the arc groove 42 to limit a rotation angle. A front end of the turntable 41 is welded with first transmission plates 43, and a pin rod 44 is inserted between the two first transmission plates 43. The locking hook 45 is connected to the first shaft blocks 15 through a movable shaft, and a tail of the locking hook 45 is welded with a second transmission plate 46. The second transmission plate 46 is provided with a movable groove 47, and the pin rod 44 is inserted into the movable groove 47. Convex platforms 33 are welded on two sides of the loading bucket 3, with a hook moth of the locking hooks 45 that can be engaged with convex platforms 33 to lock the loading bucket 3.

A discharge port 31 is provided on one side of the loading bucket 3, and installation plates 30 are symmetrically provided on two sides of the discharge port 31. A bottom of the toggle handles 50 of the discharge components 5 is provided with an inverted L-shape abutting plate 51, and two fixing plates 54 are provided at a bottom of the abutting plate 51. A second shaft rod 55 is inserted between the two fixing plates 54, and a fixing cylinder 52 is jointly provided at a top. Two sides of the fixing cylinder 52 are provided with a first shaft rod 53, and two ends of the first shaft rod 53 are flexibly connected between the two installation plates 30. A feeding port push plate 56 is provided below the fixing plates 54, and a sealing plug 57 (which can block the discharge port 31) is fixed on a front of the push plate. A third shaft rod 58 is provided at a top, and two ends of the third shaft rod 58 are flexibly connected between the two installation plates 30. A back of third shaft rod 58 is welded with a transmission component 59, and the transmission component 59 is provided with an elliptical groove 510. The second shaft rod 55 is movable and embedded in the elliptical groove 510. A torsion spring 511 is sleeved on an outer side of the fixing cylinder 52. One side of the torsion spring 511 is in contact with a bottom of the inverted L-shape abutting plate 51, and another side is in contact with an outer wall of the loading bucket 3 (located above the discharge port 31), achieving the reset of the discharge component 5. The loading bucket 3 corresponding to an outer side of the corresponding installation plates 30 is welded with a dust cover 39, and the dust cover 39 is provided on an outer side of the installation plates 30 and the discharge component 5.

A back of the installation groove 11 is provided with a fixing circular plate 71, and a front of the fixing circular plate 71 is fixedly provided with a cold guide cylinder 72 (which is provided inside the installation groove 11) by screws. The cold guide cylinder 72 is embedded with a sealing bearing 73 on one side wall away from the fixing circular plate 71. A back of the fixing circular plate 71 is fixed a driving reducer 70 with bolts. A transmission end of the driving reducer is welded with a transmission shaft 74, and the transmission shaft 74 penetrates the cold guide cylinder 72 and one end is embedded in a sealing bearing 73. A base 75 is sleeved on an outside of the cold guide cylinder 72, and a plurality of support rods 76 are welded on the base 75. A pair of spiral blades 77 are wound around an outer side of the support rods 76. Tops of the two spiral blades 77 are welded with discharge plates 78, and tops of the two discharge plates 78 are welded with connection sleeves 79. The connection sleeves 79 are fixedly provided at a top of the transmission shaft 74 to achieve the rotation of the reducer driving the spiral blades 77. Tops of the connection sleeves 79 are provided with a pair of convex points 710, which are in contact with an inner wall of the loading bucket 3, avoiding direct contact between a mixing blade and the inner wall of one side of the loading bucket 3.

There is a plurality of limit rings 26 on a top of the machine base 2, and installation columns 20 are provided inside the limit rings 26. There are connection plates 25 on two sides of a bottom of the compressor 60. The connection plates 25 correspond to a position of the installation column 20 and are welded with the docking foot sleeves 27. The docking foot sleeves 27 are inserted into the installation column 20 and fixed with screws. A square groove 22 is provided on one side of the machine base 2. A fan bracket 61 is provided on one side of the compressor 60, and two installation feet 67 are provided at a bottom of the bracket. The installation feet 67 are embedded in the square groove 22 and fixed with screws. The fan bracket 61 is provided with an air duct 63, and a front of the air duct 63 is welded with an installation bracket 64. A plurality of semi-circular bone positions 66 are welded on a back of the installation bracket 64.

There are a plurality of screw posts 610 provided on an outer wall of the fan motor 69. The screw posts 610 are embedded in the semi-circular bone positions 66 and fixed to the installation bracket 64 with screws. A motor transmission end is provided with a fan body 68. Wind deflectors 614 are provided on two sides of a back of the fan bracket 61, and a condenser 611 is provided between the two wind deflectors 614. Four corners of a back of the bracket are provided with buckles 62, and the condenser 611 is fixed with buckles 62. The drying filter 612 is fixed on the two U-shaped ribs 21 at a top of the machine base 2. The evaporator 613 is provided inside the cold guide cylinder 72, and the evaporator 613, compressor 60, condenser 611, and drying filter 612 are sequentially connected through copper pipes to form a refrigeration cycle circuit.

When it is necessary to install the loading bucket 3 onto the shaved ice machine, the guide blocks 32 on two sides of the loading bucket 3 is first aligned with the guide grooves 12 on two sides of the installation groove 11, and at the same time the cold guide cylinder 72 is aligned with a circular slot on the bucket cover 34. Then smoothly push the loading bucket 3 along the guide grooves 12. During the pushing process, the guide blocks 32 slide along the guide grooves 12 until the bucket cover 34 of the loading bucket 3 is completely pressed against the sealing gasket 18, thereby completing a preliminary positioning.

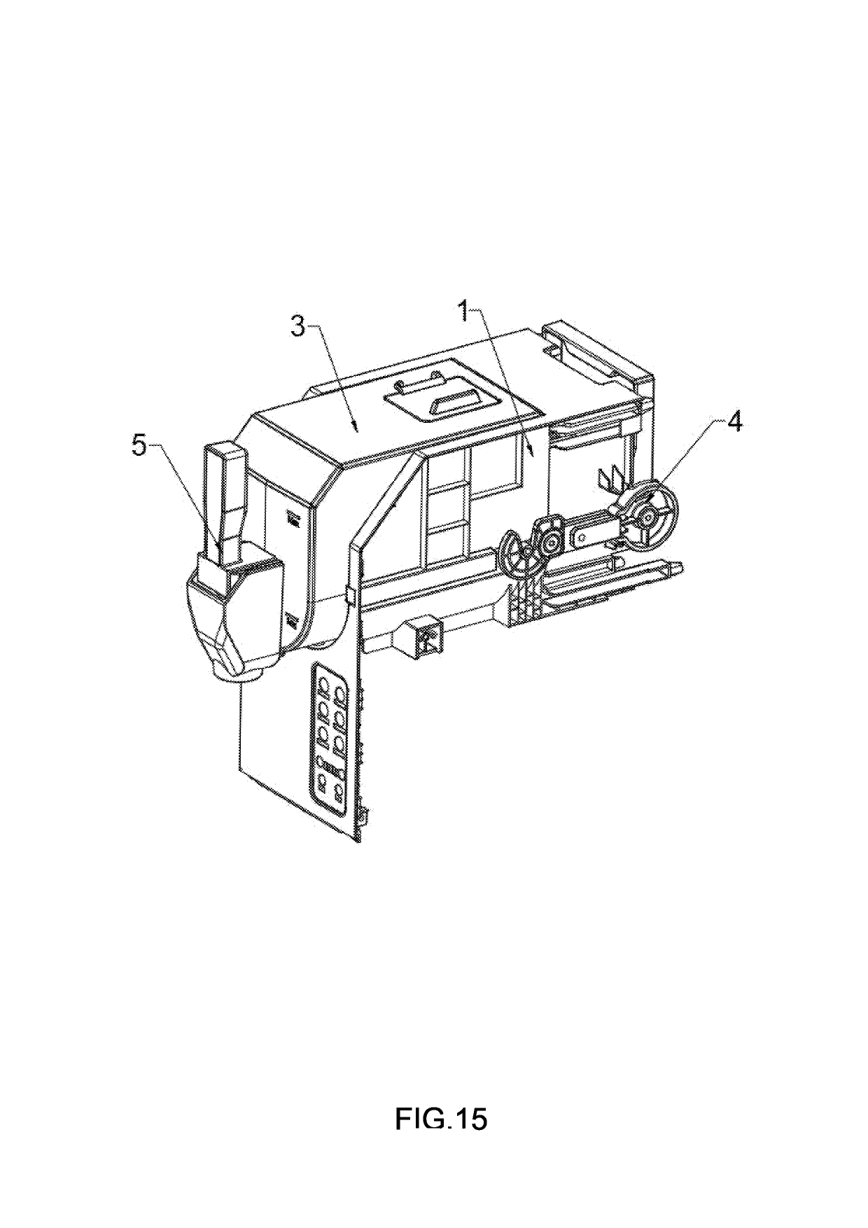

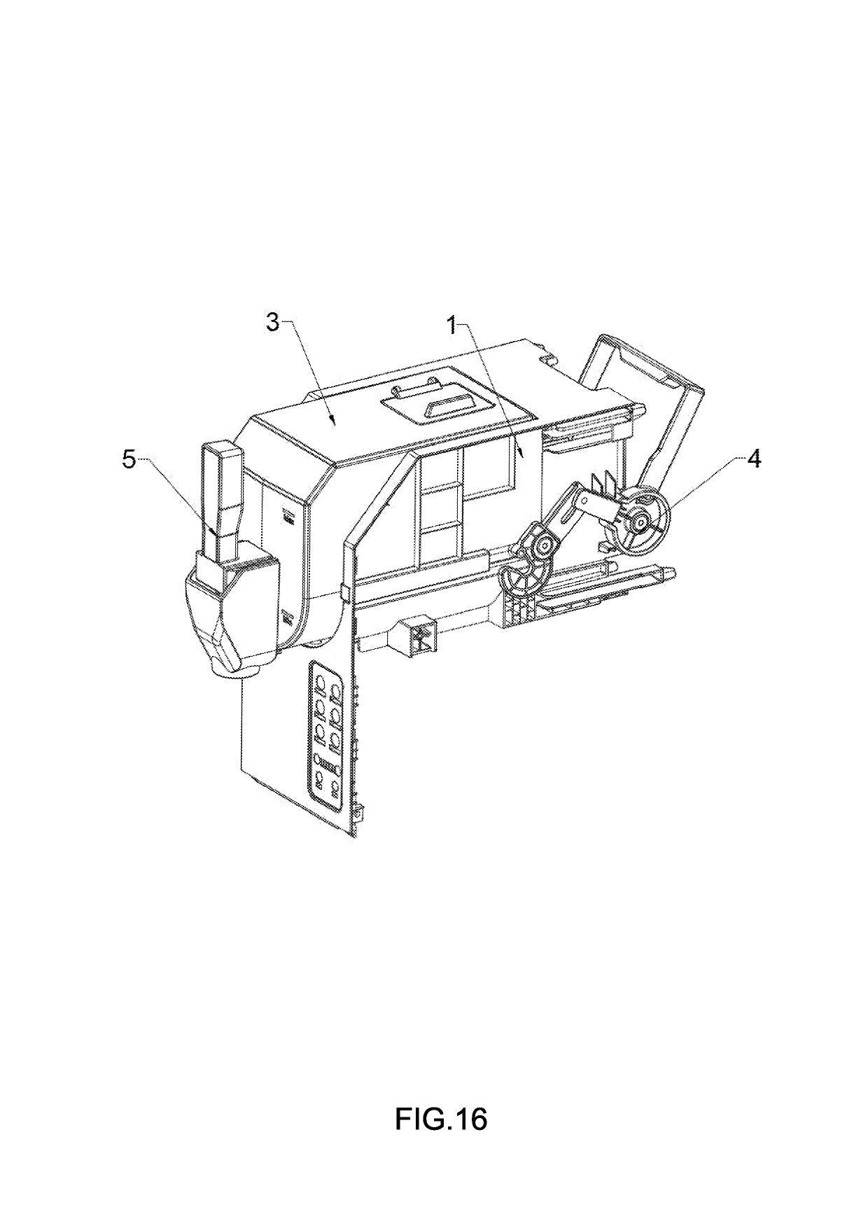

At this time, the inverted U-shaped handle 40 is manually turned at a rear of the installation shell 1 upwards, gradually rotating it from an initial inclined state (as shown in FIG. 16) to a vertical state that fits a back of the installation shell 1 (as shown in FIG. 15). During a turning process, the toggle handle 50 drives the two sides of the turntable 41 to rotate synchronously around the second shaft blocks 16. The first transmission plates 43 at a front end of the turntable 41 rotates with the turntable 41, and applies downward thrust to the second transmission plate 46 through the pin rod 44. Due to the pin rod 44 being inserted into the movable groove 47 of the second transmission plate 46, the thrust is transmitted to the second transmission plate 46, which drives the locking hook 45 to rotate downward around the first shaft blocks 15. Finally, a hook mouth of the locking hook 45 tightly engages with the convex platforms 33 on two sides of the loading bucket 3, thereby completing the mechanical locking of the loading bucket 3 and ensuring that it is stable and not loose during operation.

After starting the shaved ice machine, the driving reducer 70 is powered on and drives the transmission shaft 74 to rotate. The transmission shaft 74 drives the spiral blades 77 and the discharge plate 78 to rotate synchronously through the connection sleeve 79 at the top. During the rotation of the spiral blades 77, the materials (such as ice cubes, fruit chunks, etc.) in the loading bucket 3 are crushed and stirred to make them evenly dispersed. At the same time, the refrigeration component 6 is started, and the compressor 60 compresses the refrigerant into high-temperature and high-pressure gas, which is transported to the condenser 611 for heat dissipation and then becomes high-pressure liquid. After filtering impurities through the drying filter 612, the refrigerant enters the evaporator 613, where it evaporates and absorbs heat, causing the temperature of the cold guide cylinder 72 to rapidly decrease. The cold guide cylinder 72 transfers the low temperature to the material in the loading bucket 3, and the material gradually forms a uniform ice sand shape under continuous stirring and low temperature action.

Due to the synchronous rotation of the discharge plate 78 and the spiral blades 77, and the narrow front and wide back structure of the discharge plate 78 conforming to the material flow law, the smoothie move along the surface of the discharge plate 78 towards the discharge port 31 of the loading bucket 3 under the centrifugal force and the pushing effect of the spiral blades 77, preparing for subsequent discharge.

When it is necessary to discharge the material, a user holds the toggle handle 50 of the discharge component 5 with his hand and applies a downward force. The toggle handle 50 drives the inverted L-shape abutting plate 51 to rotate around the first shaft rod 53 as an axis, and the two fixing plates 54 at a bottom of the abutting plate swing backwards accordingly. The second shaft rods 55 between the fixing plates 54 move backwards in the same step. The second shaft rods 55 slide in the elliptical groove 510 of the transmission component 59 and push a rear wall of the elliptical groove 510, the transmission component 59 is driven to rotate backward with the third shaft rod 58 as an axis. When the transmission component 59 rotates, the feeding port push plate 56 connected to it swings forward, the sealing plug 57 is caused to separate from the discharge port 31, and the discharge port 31 opens. The smoothie in the loading bucket 3 flows out from the discharge port 31 under the action of gravity, completing the discharge. After the user releases grip, the user no longer applies force to the toggle handle 50. At this point, the torsion spring 511, which is in a compressed state, releases its elastic potential energy. One side of the torsion spring 511 contacts the outer wall of the loading bucket 3, generating a forward thrust that acts on the transmission component 59, it is caused to rotate forward around the third shaft rod 58 as the axis. A front wall of the elliptical groove 510 on the transmission component 59 pushes the second shaft rod 55 forward, the fixing plates 54 and the inverted L-shape abutting plate 51 are driven to rotate in opposite direction with the first shaft rod 53 as an axis. The toggle handle 50 is reset, and at the same time, the feeding port push plate 56 swings backward with the transmission component 59. The sealing plug 57 is re-inserted into the discharge port 31, thereby achieving the sealing of the discharge port 31. The entire device returns to its initial state and waits for the next discharge.

During the operation of the equipment, low temperature generated by the evaporator 613 will be conducted to the loading bucket 3 and the installation shell 1, causing the surface temperature of the two to be lower than an ambient temperature. The water vapor in the air condenses into water droplets (condensate) when it is cooled. The condensate flows on the surfaces of the loading bucket 3 and the installation groove 11 and is guided by the inclined angle of the bottom surface of the installation groove 11. It gradually converges into the drainage recess 13 at lower side and then flows into the drainage pipe 14 through the drainage hole 19. Finally, it enters the guide tube 24 of the machine base 2 along the drainage pipe 14 and is discharged into the water-receiving tray 8 in the insertion groove 23 from a tail end of the guide tube 24 to avoid the condensate dripping and polluting the environment.

It should be understood that the above specific embodiments of the present disclosure are only for illustrative purposes or to explain the principles of the present disclosure , and do not constitute limitations on the present disclosure . Therefore, any modifications, equivalent substitutions, improvements, etc. made without deviating from the spirit and scope of the present disclosure should be included in the protection scope of the present disclosure. Besides that, the claims attached to the present disclosure are intended to cover all changes and modifications falling within the scope and boundaries of the attached claims, or equivalent forms of such scope and boundaries.

What is claimed is:

1. A shaved ice machine, comprising: an installation shell, wherein a tail of the installation shell is provided with a locking component, the installation shell is provided with an installation groove, and a detachable loading bucket is provided inside the installation groove;
the loading bucket is connected to the locking component, and a front of the loading bucket is provided with a discharge component;
the installation shell is provided with a stirring component, and the stirring component is provided inside the loading bucket;
a front bottom of the installation shell is provided with a front panel, and the front panel is provided with a control panel;
a bottom of the front panel is provided with a machine base, and the machine base is provided with a refrigeration component,
two sides of the installation shell and two sides of the machine base are both provided with side heat dissipation plates, and a back of the installation shell and a back of the machine base are both provided with rear heat dissipation plates.

2. The shaved ice machine according to claim 1, wherein an inner bottom surface of the installation groove is inclined, and a drainage recess is provided on a lower side of the inner bottom surface of the installation groove;
a drainage hole is provided in a middle of the drainage recess, and a drainage pipe is provided at a bottom of the drainage hole;
a guide tube is provided at a top of the machine base corresponding to a position of the drainage pipe, and an insertion groove is provided at a front of the machine base;
the guide tube is comminated to the insertion groove, and a front of the front panel is provided with a water-receiving tray, and one side of the water-receiving tray is inserted into the insertion groove.

3. The shaved ice machine according to claim 1, wherein guide grooves are symmetrically provided on inner walls of two sides of the installation groove,
a pair of guide blocks are horizontally provided on two sides of the loading bucket corresponding guide grooves,
a discharge port is provided on one side of the loading bucket, and installation plates are symmetrically provided on two sides of the discharge port;
the discharge component is provided between two installation plates, and a dust cover is provided on the same side of the loading bucket;
the dust cover is provided on an outer side of the two installation plates, and one side of the loading bucket away from the discharge component is welded with a bucket cover;
triangular ribs are provided on an edge of one side of the loading bucket that is close to the bucket cover;
the bucket cover is provided with a concave docking groove at a position corresponding to the triangular ribs, and the triangular ribs are provided in the concave docking groove;
an outer wall of one side of the loading bucket that is close to the bucket cover is provided with a plurality of clamping grooves, and a convex block is provided on one side of the bucket cover at a position corresponding to the clamping grooves;
the convex block is inserted into the clamping grooves, and a feeding cover is provided on one side of a top of the loading bucket.

4. The shaved ice machine according to claim 3, wherein a pair of first shaft blocks are symmetrically provided on outer walls of two sides of the installation shell, and the two first shaft blocks are respectively provided at a rear of the two guide grooves;
a pair of second shaft blocks are also symmetrically provided on outer walls of two sides of the installation shell, and the two second shaft blocks are respectively provided at rears of the two first shaft blocks;
a limit rod is provided above each of the second shaft blocks.

5. The shaved ice machine according to claim 4, wherein the locking component comprises an inverted U-shaped handle, bottoms of two sides of the inverted U-shaped handle are symmetrically provided with turntable;
the turntables are movable on the second shaft blocks, and an arc groove is provided on the turntables;
the limit rod is provided inside the arc groove;
a pair of first transmission plates are symmetrically provided at front ends of the turntables, and a pin rod is provided between the two first transmission plates;
locking hooks are movable on the two first shaft blocks, and a tail of the locking hooks is provided with a second transmission plate;
an upper of the second transmission plate is provided with a movable groove, and the pin rod is provided inside the movable groove;
a pair of convex platforms are symmetrically provided on two sides of the loading bucket corresponding to positions of the locking hooks.

6. The shaved ice machine according to claim 5, wherein the discharge component comprises a toggle handle, a bottom of the toggle handle is provided with an inverted L-shape abutting plate, a bottom of the inverted L-shape abutting plate is provided with a pair of fixing plates, two second shaft rods are provided between the two fixing plates, and fixing cylinders are simultaneously provided at tops of the two fixing plates,
first shaft rods are symmetrically provided on two sides of the fixing cylinder;
underneath the two fixing plates, there is a feeding port push plate, and a front of the feeding port push plate is provided with a sealing plug;
a top of the feeding port push plate is provided with a third shaft rod, and a back of the third shaft rod is provided with a transmission component, and the transmission component is provided with an elliptical groove;
the transmission component is provided between the two fixing plates, and the second shaft rod is movable in the elliptical groove;
the first shaft rod and the third shaft rod are both movable between the two installation plates;
two sides of the fixing cylinder are simultaneously sleeved with torsion springs, and one side of the torsion springs is pressed against a bottom of the inverted L-shape abutting plate, the other side of the torsion springs is supported on an outer wall of the loading bucket and provided above the discharge port.

7. The shaved ice machine according to claim 6, wherein the stirring component comprises a fixing circular plate provided on a back of the installation groove, and a front of the fixing circular plate is fixed with a cold guide cylinder through a plurality of screws;
the cold guide cylinder is provided in the installation groove, and a sealing bearing is provided in a wall of the cold guide cylinder on one side away from the fixing circular plate;
a back of the fixing circular plate is provided with a driving reducer, and a transmission shaft is provided on a transmission end of the driving reducer;
the transmission shaft is provided inside the cold guide cylinder, with one end provided inside the sealing bearing, an outer side of the cold guide cylinder is sleeved with a base, and the base is provided with a plurality of support rods;
a pair of spiral blades are simultaneously wound around outer sides of the plurality of support rods, and each of the spiral blades is provided with a discharge plate at a top;
a connection sleeve is provided between top ends of the two discharge plates, and the connection sleeve is provided at a top of the transmission shaft;
a sealing gasket is provided on an inner wall of the installation groove, and the sealing gasket is provided on an outer side of the cold guide cylinder, and the bucket cover is pressed against the sealing gasket;
the discharge plate is a narrow front and wide rear structure, and a pair of convex points are provided at a top of the connection sleeve.

8. The shaved ice machine according to claim 7, wherein a top of the machine base is provided with a plurality of limit rings, each of the limit rings is provided with an installation column, one side of the machine base is provided with a square groove, and one side of a top of the machine base is further provided with a pair of U-shaped ribs.

9. The shaved ice machine according to claim 8, wherein the refrigeration component comprises a compressor provided on the machine base, and connection plates are symmetrically provided on two sides of a bottom of the compressor;
the connection plates are provided with docking foot sleeves at positions corresponding to a plurality of installation columns, and the docking foot sleeves are inserted into the limit rings and sleeved on outsides of the installation columns;
the installation columns and the docking foot sleeves are fixed by screws, and a fan bracket is provided on one side of the compressor,
a bottom of the fan bracket is provided with a pair of installation feet, and two installation feet are respectively provided in two square grooves, and the square grooves and the installation feet are fixed by screws;
an air duct is provided inside the fan bracket;
an installation bracket is provided on a front of the air duct, and a plurality of screw holes are provided on the installation bracket;
a back of the installation bracket is provided with a plurality of semi-circular bone positions, and the plurality of semi-circular bone positions are respectively provided on one side of the plurality of screw holes;
the back of the installation bracket is further provided with a fan motor, and a fan body is provided on a transmission end of the fan motor;
positions of the fan motor corresponding to the plurality of semi-circular bone positions are provided with a plurality of screw posts,
the plurality of the screw posts are respectively provided in the plurality of semi-circular bone positions and fixed with screws;
two sides of a back of the fan bracket are symmetrically provided with wind deflectors, and a condenser is provided between the two wind deflectors;
a plurality of buckles are provided on four corners of the back of the fan bracket, and the condenser is clamped on the plurality of buckles;
a drying filter is provided on the two U-shaped ribs, and an evaporator is provided inside the cold guide cylinder;
the evaporator, compressor, condenser, and drying filter are sequentially connected through copper pipes.
